(19) United States
(12) Patent Application Publication
(10) Pub. No.: US 2026/0244402 A1
(43) Pub. Date: Aug. 20, 2026

(54) COMPUTE IN MEMORY ARCHITECTURE THAT ALLOWS FLEXIBLE FLOATING-POINT OPERATIONS

(71) Applicant: OpenAI Opco, LLC, San Francisco, CA (US)

(72) Inventor: Mohammed Elneanaei Abdelmoneem Fouda, Alexandria, VA (US)

(73) Assignee: OpenAI Opco, LLC, San Francisco, CA (US)

(21) Appl. No.: 19/542,310

(22) Filed: Feb. 17, 2026

Related U.S. Application Data
(60) Provisional application No. 63/759,882, filed on Feb. 18, 2025.

(51) Int. Cl. G06F 7/544; G06F 7/483

(52) U.S. Cl. CPC G06F 7/5443; G06F 7/483; G06F 2207/382

(57) ABSTRACT

The disclosure describes systems and methods for mixed-mode, mixed-precision computation using a configurable compute engine for vector–matrix operations. A processing system selects an operating mode including at least a floating-point mode or an integer mode for the compute engine. Operand storage and format preprocessing route differently sized element representations through shared lanes. In floating-point mode, compute circuitry generates a mantissa product and a product exponent, and alignment applies power-of-two control through a selection network, including as part of a fused multiply-accumulate path. Parallel adder trees feed a hierarchical output accumulator sized to the selected precision. Normalization operates at a wider intermediate precision, applies block-level scaling with dequantization, and, in lower-precision operation, performs groupwise normalization with an intermediate-precision combine to preserve a constant compute-block size. Implementations integrate the compute engine within a memory macro with double buffering or deploy the compute engine as a standalone accelerator.

### CROSS-REFERENCE TO RELATED APPLICATIONS

This application claims the benefit, pursuant to 35 U.S.C. § 119(e) and 37 C.F.R. § 1.78(a), of U.S. Provisional Application No. 63/759,882, filed February 18, 2025. The disclosure of U.S. Provisional Application No. 63/759,882 is hereby incorporated by reference herein in its entirety.

### BACKGROUND

Modern compute architectures for machine learning (ML) and signal-processing workloads increasingly employ specialized engines to accelerate vector–matrix operations while accommodating multiple numeric formats. In many contexts, such engines may support floating-point precisions with compact encodings (e.g., eight-bit and four-bit formats) as well as integer modes, enabling trade-offs among throughput, dynamic range, and resource utilization. These designs may be integrated with on-chip memory structures and control logic that coordinate operand provisioning, intermediate accumulation, and output formatting across diverse operating conditions.

Supporting multiple numeric representations and precision levels can increase datapath and control complexity and can introduce tradeoffs among throughput, latency, and energy consumption. Designers often seek architectures that maintain predictable behavior as workloads shift among formats and precisions while managing overhead associated with format conversion, intermediate representation, and output formatting.

Quantized and mixed-precision workflows can also introduce scale management and numeric consistency concerns, including how intermediate values are normalized, scaled, and formatted before producing outputs suitable for downstream computation or storage.

Implementation choices in these areas can influence numerical fidelity, area, and energy consumption across different accelerator and platform styles, including standalone accelerators and implementations integrated near memory structures.

### SUMMARY

The present disclosure provides systems, methods, and techniques that perform mixed-mode, mixed-precision computation in a unified compute engine for vector–matrix operations. A processing system selects a mode and a precision and gates inactive datapath portions so the compute engine sustains predictable operation while reducing energy and control overhead across precision changes.

Using mode/precision control in this manner may allow a single compute engine to serve different accuracy, throughput, and power targets without changing an outward command structure; for instance, selecting a four‑bit floating‑point precision may cause the compute engine to reuse shared datapath lanes with packed elements and to gate unneeded adder‑tree subsets while keeping the same command format used for eight‑bit floating‑point work.

The present disclosure provides a datapath that routes element representations of different bit widths through shared lanes and that supports both floating-point and integer operation without requiring software to restructure kernels or buffer shapes. In floating-point mode, compute circuitry produces a mantissa product and a product exponent and applies exponent-driven alignment using a power-of-two generator and a selection network. In compact formats, format preprocessing performs bounded pre-accumulation shifts so contributions enter reduction with reduced shifter complexity, and in certain embodiments the engine fuses alignment behavior into the accumulation path.

The present disclosure provides accumulation circuitry that reduces contributions using multiple parallel adder trees and combines partial sums using a hierarchical output accumulator sized to the selected precision. The processing system selectively power-gates or clock-gates subsets of the reduction fabric responsive to the selected mode and precision, and a mode-dependent shifter applies fixed shift policies across supported precisions. Normalization circuitry operates using a wider intermediate precision to preserve numerical behavior, applies block-level scaling with dequantization, and in lower-precision operation performs groupwise normalization with an intermediate-precision combine to maintain a desired compute-block size across numeric formats.

In some embodiments, a computing system includes a processing system comprising one or more processors and a compute engine coupled to the processing system. The processing system is configured to select a mode including at least a floating-point mode, select a precision from multiple precisions, and gate portions of the compute engine responsive to the selected mode and the selected precision. The compute engine includes operand storage, compute circuitry that in floating-point mode produces a mantissa product and a product exponent, alignment circuitry including a power-of-two generator and a selection network coupled to the compute circuitry, accumulation circuitry including a plurality of parallel adder trees and a hierarchical output accumulator, format preprocessing circuitry that routes element representations of different bit widths through shared lanes, and normalization circuitry that forms an output value in a numeric format using a wider intermediate precision.

In some aspects, a method includes selecting, by a processing system, a mode including at least a floating-point mode; selecting a precision from multiple precisions; and gating portions of a compute engine responsive to the selected mode and the selected precision. The method performs format preprocessing to route element representations of different bit widths through shared lanes, produces in floating-point mode a mantissa product and a product exponent, aligns the mantissa product using a power-of-two value corresponding to the product exponent via a selection network, accumulates partial results using parallel adder trees and a hierarchical output accumulator, and normalizes accumulated results using a wider intermediate precision to form an output value in a numeric format.

In yet other aspects, an apparatus includes a processing system configured to select a mode including at least a floating-point mode, select a precision from multiple precisions, and gate portions of the apparatus responsive to the selected mode and the selected precision; operand storage; compute circuitry; alignment circuitry including a power-of-two generator and a selection network; accumulation circuitry including parallel adder trees and a hierarchical output accumulator; format preprocessing circuitry that routes different bit-width element representations through shared lanes; and normalization circuitry that forms an output value in a numeric format using a wider intermediate precision.

The present disclosure supports multiple integration styles, including implementations that integrate the compute engine within or near memory structures with operand staging and double buffering, implementations that deploy the compute engine as a standalone accelerator, and implementations that map the datapath to systolic arrays with compute cells that stream operands between neighbors during multiply-accumulate operation.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 is a high-level block diagram of a computing system showing a processing system coordinating a compute engine to produce results.

FIG. 2 is a system-level block diagram that presents the overall mixed-precision datapath from input provisioning through output formation.

FIG. 3A is a block diagram of a format-preprocessing stage that generally illustrates how operands are prepared and routed based on mode and precision.

FIG. 3B is a block diagram highlighting the compute stage at a conceptual level where operand components are generated for later alignment.

FIG. 3C is a block diagram that abstractly depicts the alignment mechanism applying exponent-based scaling before accumulation.

FIG. 4A is a block diagram of an accumulation subsystem illustrating parallel reduction and hierarchical accumulation with precision-aware resource use.

FIG. 4B is a block diagram of an alternate accumulation embodiment in which alignment functionality is integrated within the accumulation datapath.

FIG. 5 is a block diagram of a normalization subsystem that shows per-group processing and intermediate-precision combination to produce formatted outputs.

FIG. 6 is a flow diagram summarizing a representative method of operating the compute engine across mode selection, precision control, processing, and output generation.

### DETAILED DESCRIPTION

The following disclosure provides various embodiments and examples for implementing features of the present disclosure. Specific examples of components and arrangements are described to simplify the present disclosure. These examples are not intended to be limiting. For instance, the formation of a first feature over or on a second feature may include embodiments in which the two features are in direct contact, as well as embodiments in which additional features are interposed between them. Reference numerals and/or letters may be repeated across examples for clarity and simplicity, and such repetition does not imply a specific relationship between embodiments.

Some of the disclosed embodiments are described with reference to the accompanying drawings. However, it will be understood by those skilled in the art that the principles of the example methods and systems may be practiced without every specific detail. Well-known methods, procedures, and components have not been described in detail so as not to obscure the principles of some of the disclosed methods and systems. Unless explicitly stated, the example methods and processes described herein are neither constrained to a particular order or sequence nor constrained to a particular system configuration. Additionally, some of the described methods and systems or elements thereof can occur or be performed (e.g., executed) simultaneously, at the same point in time, or concurrently. Reference will now be made in detail to some of the disclosed methods and systems, examples of which are illustrated in the accompanying drawings.

It is to be understood that both the foregoing general description and the following detailed description are only explanatory and are not restrictive of this disclosure. The accompanying drawings, which are incorporated in and constitute a part of this specification, illustrate several disclosed methods and systems and together with the descriptions serve to outline principles of some of the disclosed methods and systems.

Spatially relative terms such as “beneath,” “below,” “lower,” “above,” “upper,” and similar descriptors are used for convenience in describing the relative positioning of elements as illustrated in the figures. These terms are intended to encompass different orientations of the device in use or operation, and should not be interpreted as limiting the scope of the present disclosure to the depicted orientation.

The disclosed technology involves systems and methods for mixed precision computation and datapath control in high performance compute engines. In some implementations, the systems and methods may provide techniques for operand representation and preprocessing, alignment and accumulation across floating point and integer numeric formats (e.g., FP8 and FP4), selective gating of compute resources, and normalization/dequantization using a wider intermediate precision, applicable to vector–matrix multiplication accelerators implemented in or alongside memory macros and/or arranged as systolic arrays.

In acceleration engines that may operate across multiple numeric formats, transitions among representations and alignment of intermediate results may materially affect area, power, and schedule if handled in separate, heavyweight stages. Compact floating‑point encodings such as eight‑bit and four‑bit formats may change mantissa and exponent granularity, while an integer mode may introduce distinct sign semantics. A single engine that reuses datapaths across these modes improves efficiency and consistency by routing different bit‑width element representations through shared lanes, performing only limited preprocessing tailored to the active mode, and fusing alignment where appropriate to eliminate extra passes over partial results and reduce datapath overhead.

The disclosed architecture drives high performance by enforcing an alignment policy that matches the active numeric format. In floating‑point modes, the product exponent directly determines a power‑of‑two factor used to scale mantissa products, and the engine applies this exponent‑driven alignment within the accumulation path to reduce latency and data movement. In very narrow formats such as four‑bit, the engine uses bounded, pre‑accumulation shifts to keep alignment hardware compact while still feeding the reduction fabric in an aligned form. The accumulation stage executes with multiple parallel adder trees sized to the intended input widths and selectively gates (including fully deactivating, where appropriate) unused portions of the reduction fabric when a lower precision is active, thereby saving energy while maintaining a consistent, software‑visible schedule.

The disclosed normalization and scaling pipeline preserves output fidelity by normalizing with a wider intermediate precision and by managing activation scaling at a compute‑block granularity that remains consistent across modes (e.g., a block size of thirty‑two). To keep that same block size in a lower‑precision mode, the engine partitions inputs into groups, accumulates and normalizes the groups separately, and then combines the normalized group results at the intermediate precision, which retains numerical behavior without sacrificing throughput. The architecture uses an intermediate‑precision combiner and appropriate normalization resources to secure both accuracy and steady performance, and it overlaps operand loading with computation via double buffering to further improve effective throughput. These mechanisms support implementations in or adjacent to memory macros and in systolic‑array arrangements while preserving a clean, higher‑level control model.

In some implementations, the processing system may select a mode that includes at least a floating‑point mode, may select a precision from multiple precisions, and may gate portions of a compute engine responsive to the selected mode and the selected precision. For example, the compute engine may include operand storage for operand values; compute circuitry that, in the floating‑point mode, may produce a mantissa product and a product exponent; alignment circuitry that may include a power‑of‑two generator and a selection network coupled to the compute circuitry; accumulation circuitry coupled to outputs of the compute circuitry that may include plural parallel adder trees feeding a hierarchical output accumulator; format preprocessing arranged along input paths and coupled between the operand storage and at least one of the compute circuitry and the accumulation circuitry to route element representations of different bit widths through shared lanes; and normalization circuitry coupled to the hierarchical output accumulator that may form an output value in a selected numeric format using a wider intermediate precision. Mode and precision selection may let the system trade dynamic range and numerical fidelity for throughput and power, while gating may reduce switching activity for portions of the engine that are not needed under a given precision or mode.

The selected precision may include eight‑bit floating‑point and/or four‑bit floating‑point. The compute circuitry may combine operand signs when forming a mantissa product; the alignment circuitry may align the mantissa product in floating‑point mode using a power‑of‑two value associated with the product exponent; the format preprocessing may perform limited alignment shifts prior to accumulation; and the accumulation circuitry may enable a subset of the parallel adder trees responsive to the selected precision or numeric format. These choices may preserve correct floating‑point semantics while bounding hardware cost and allowing the same datapath to operate efficiently across precisions.

The alignment circuitry may be integrated within the accumulation circuitry such that alignment using an exponent‑derived power‑of‑two factor may occur as part of a fused multiply‑accumulate path through the parallel adder trees. Performing alignment within the accumulation path may reduce intermediate buffering and may shorten the cycle count relative to a separate align‑then‑accumulate stage.

Further, when a four‑bit floating‑point precision is selected, the format preprocessing may route a packed element representation in which two four‑bit lanes may be stored within an eight‑bit storage unit. Packing may increase lane utilization and may keep wiring and multiplexing similar to eight‑bit operation while still feeding the engine at the desired rate.

Additionally, or alternatively, when a four‑bit floating‑point precision is used, the format preprocessing may perform limited alignment shifts including, for example, six shifts prior to accumulation. However, less shifts may be implemented if desired. Limiting the shift range in this way may constrain shifter complexity, ease timing closure, and still align partials to the exponent granularity used by the compact format. In some embodiments, the number of alignment shifts is configurable and may vary with numeric format, exponent range, and/or performance configuration, such that the six‑shift example is not limiting.

In some embodiments, the accumulation circuitry may include at least two sets of adder trees having different input widths, such as a first set with a greater input width that may accept accumulation of packed four‑bit operands and a second set with a smaller input width; the processing system may gate the second set in a lower‑precision mode. Differentiating input widths may map hardware to the data packing and may avoid toggling unused adders when narrower precisions are active.

The normalization circuitry may accumulate and normalize using a wider floating‑point intermediate precision including at least twenty‑two bits and may apply scaling associated with a compute block, with dequantization performed within the normalization circuitry. Using a wider intermediate precision may preserve headroom for rounding and scaling, which may help avoid saturation or clipping when combining many partials.

The normalization circuitry may include two normalization units that may operate in a lower‑precision mode to maintain a compute‑block size of thirty‑two across numeric formats. Maintaining a consistent block size may simplify software tiling, buffer sizing, and control scheduling across modes.

The compute engine may be implemented as a memory macro that includes one or more memory arrays configured to store weight values, and at least a portion of the compute circuitry may be integrated in the memory macro to perform multiply‑accumulate operations using the stored weight values; operand storage may include a double buffer configured to enable simultaneous loading of operand values and computing of results. Locating compute near stored weights and overlapping load with compute may reduce external bandwidth demand and may improve energy per operation.

In some aspects of the disclosed technology, a set of input activations may be partitioned into at least two groups, accumulation for each group may proceed through a respective adder tree and a respective normalization‑and‑dequantization block, and normalized group results may be combined using an intermediate‑precision addition; a floating‑point mode with a first precision may use a single activation scale shared across the groups while a floating‑point mode with a second, lower precision may use at least two activation scales corresponding to the groups. Groupwise scaling may preserve dynamic range under narrow formats while keeping the compute block consistent across modes.

Alignment may be effected by applying within the accumulation circuitry a power‑of‑two factor derived from a product exponent; a shifter in the accumulation path may apply a fixed left shift in an eight‑bit floating‑point precision and a zero shift in a four‑bit floating‑point precision. A fixed shift policy may simplify control and may place partial sums in a numerically convenient range for the downstream accumulator and normalizer.

The plurality of parallel adder trees may include a first subset having adders with a first input width sized to accept accumulation of packed four‑bit operands and a second subset having adders with a second, smaller input width, and gating portions of the compute engine may include power‑gating or clock‑gating the second subset when the selected precision is four‑bit. Such gating may lower dynamic and leakage power while retaining peak capacity when a wider precision is selected.

The format preprocessing circuitry may include selector multiplexers configured to route either a single eight‑bit element representation along a dedicated datapath lane or four‑bit element representations packed in an eight‑bit storage unit along shared datapath lanes toward the compute and accumulation stages. Selector‑based routing may reuse lanes across precisions and may avoid duplicating interconnect.

The format preprocessing circuitry may detect whether an operand value is a normal value or a subnormal value and may set an implicit leading mantissa bit to a first value for normal values and to a second value for subnormal values. Establishing the leading bit in preprocessing may help ensure that mantissas are formed consistently for subsequent multiplication and alignment.

The compute circuitry may comprise a plurality of compute cells arranged as a systolic array that may stream operand values between neighboring compute cells while performing multiply‑accumulate operations. Streaming between neighbors may reduce memory traffic and may allow smaller local buffers while maintaining throughput.

The selected mode may include an integer mode, and the format preprocessing circuitry may perform two’s‑complement sign handling prior to accumulation. Handling sign semantics up front may allow the same accumulation hardware to be reused for integer and floating‑point operation without separate datapaths.

The disclosed technology may also be implemented as a method of operating the compute engine may include selecting a mode that includes at least a floating‑point mode; selecting a precision from multiple precisions; gating portions of the engine responsive to the selected mode and the selected precision; in the floating‑point mode, causing compute circuitry to produce a mantissa product and a product exponent; aligning using alignment circuitry that may include a power‑of‑two generator and a selection network; accumulating partial results using accumulation circuitry that may include plural parallel adder trees and a hierarchical output accumulator; performing format preprocessing along input paths to route element representations of different bit widths through shared lanes; and normalizing accumulated results using normalization circuitry that may form an output value in a selected numeric format using a wider intermediate precision. This flow may enable a unified engine to operate across data formats while keeping data movement, latency, and energy within target budgets.

In some situations, the method may be implemented having the selected precision including at least an eight‑bit floating‑point precision and a four‑bit floating‑point precision so that a single datapath may serve differing accuracy and throughput targets without changing the software model.

The alignment circuitry may be integrated within the accumulation circuitry such that, in the floating‑point mode, alignment using the power‑of‑two value corresponding to the product exponent may occur as part of a fused multiply‑accumulate path through the parallel adder trees. Fusing alignment may reduce staging overhead and control complexity.

And when the selected precision includes the four‑bit floating‑point precision, the format preprocessing may route a packed element representation in which two four‑bit lanes may be stored within an eight‑bit storage unit. Packing in this manner may double effective lane utilization at narrow precision.

In situations, the method can be implemented so when the selected precision includes the four‑bit floating‑point precision, the format preprocessing may perform limited alignment shifts including, for example, six (or less) shifts prior to accumulation. Bounding shifts may keep the critical path short and area modest for compact modes.

In some embodiments of the method, the accumulation circuitry may include at least two sets of adder trees having different input widths, and the processing system may gate one of the sets in a lower‑precision mode. This approach may align active hardware with data width to reduce power without compromising peak capability.

In some embodiments of the method, the normalization circuitry may accumulate and normalize using a wider floating‑point intermediate precision including at least twenty‑two bits and may apply scaling associated with a compute block, with dequantization performed within the normalization circuitry. Intermediate‑precision normalization may support consistent rounding and scale application across kernels.

The normalization circuitry may include two normalization units operative in a lower‑precision mode to maintain a compute‑block size of thirty‑two across numeric formats. Maintaining the same block size may simplify scheduling and improve locality for shared kernels.

A mode selected by the processing system may include an integer mode, and the format preprocessing may perform two’s‑complement sign handling prior to accumulation so that an accumulation fabric may be reused across modes without introducing extra sign‑correction stages.

Some aspects of the present disclosure are directed to an apparatus configured for processing operand values in multiple numeric formats may include a processing system that may select a mode including at least a floating‑point mode, select a precision from multiple precisions, and gate portions of the apparatus responsive to the selected mode and the selected precision; operand storage for operand values; compute circuitry that, in the floating‑point mode, may produce a mantissa product and a product exponent; alignment circuitry that may include a power‑of‑two generator and a selection network coupled to the compute circuitry; accumulation circuitry coupled to outputs of the compute circuitry that may include plural parallel adder trees and a hierarchical output accumulator; format preprocessing circuitry arranged along input paths that may route element representations of different bit widths through shared lanes; and normalization circuitry coupled to the hierarchical output accumulator that may form an output value in a selected numeric format using a wider intermediate precision. Consolidating these elements in a single apparatus may allow deployment as a standalone accelerator, a macro within a memory subsystem, or a tile in a larger array while maintaining common control semantics across formats.

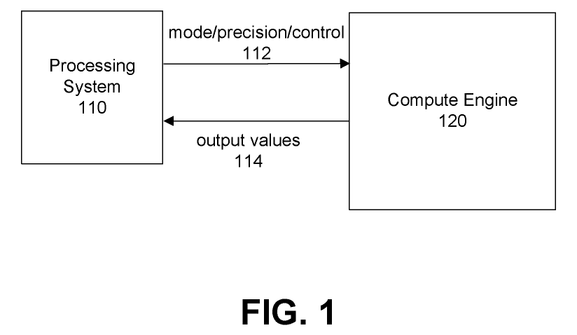

FIG. 1 is a block diagram of a computing system that coordinates a host‑side controller with a specialized compute datapath to generate results in selectable numeric formats. In the arrangement shown, processing system 110 may configure and supervise compute engine 120 via mode/precision/control 112 and may receive output values 114 produced by compute engine 120. The diagram may illustrate functional relationships rather than physical placement, and the interconnections may be realized with on‑chip buses, memory‑mapped control registers, dedicated links, or other signaling appropriate to the integration.

Processing system 110 may include one or more programmable processors, microcontrollers, or control state machines that may coordinate operation of compute engine 120. Processing system 110 may present a software‑visible control plane through which firmware or a driver may select a mode, select a precision, and provide parameters for gating, scaling, data movement, and output formatting. The control plane may be implemented with memory‑mapped configuration registers, a command queue for dispatching workloads, and status or interrupt signaling to indicate completion or exception conditions. For example, processing system 110 may prepare a job descriptor that may identify a numeric mode (such as a floating‑point mode or an integer mode), a selected precision (such as eight‑bit floating‑point or four‑bit floating‑point), operand locations, scale policies, and destination buffers, and may arm compute engine 120 to begin processing. In some implementations, processing system 110 may also manage power and clock domains for compute engine 120 so that unused subunits may be gated when a lower precision is active, which may reduce switching activity and energy while preserving the same external programming model.

Mode/precision/control 112 may represent the collection of control signals, configuration fields, and status paths by which processing system 110 may direct compute engine 120 and by which compute engine 120 may report operating state. A mode selection may indicate an arithmetic context that may influence sign handling and exponent or scale semantics (for example, floating‑point versus integer), while a precision selection may indicate an encoding width or format that may affect operand packing, adder‑tree utilization, normalization width, and gating choices (for example, eight‑bit floating‑point versus four‑bit floating‑point). Additional control parameters may include compute‑block size, scale granularity, buffer depths, and start/stop signaling. During operation, mode/precision/control 112 may carry writeable configuration (such as precision selects, gating masks, base addresses for operand storage, and destination addresses for output values), readable status (such as busy/idle, error and saturation flags, and per‑block summaries), and event indications (such as interrupts signaling completion of a compute block). Using mode/precision/control 112 in this manner may allow a single compute engine 120 to serve different accuracy, throughput, and power targets without changing the outward command structure; for instance, selecting a four‑bit floating‑point precision may cause compute engine 120 to reuse shared datapath lanes with packed elements and to gate unneeded adder‑tree subsets while keeping the same command format used for eight‑bit floating‑point work. In some embodiments, gating the unneeded adder‑tree subsets may include fully deactivating one or more adder trees during a lower‑precision mode. Such deactivation may be implemented by power‑gating and/or clock‑gating the adder‑tree subset (and, in some embodiments, by input isolation) so that the deactivated adder trees remain inactive while the lower‑precision mode is selected.

Compute engine 120 may include operand storage, format preprocessing, compute paths, alignment logic, accumulation structures, and normalization circuitry that together may generate output values 114 consistent with the mode and precision selected via mode/precision/control 112. Operand storage may comprise one or more buffers or double‑buffer structures that may stage input activations and weights so that data loading may overlap with computation. Format preprocessing may route element representations of different bit widths through shared lanes; in an integer mode it may perform two’s‑complement sign handling, and in compact floating‑point formats it may establish mantissas for normal and subnormal values prior to multiplication and accumulation. In a floating‑point mode, compute paths may produce a mantissa product and a product exponent; alignment logic may apply a power‑of‑two factor associated with the product exponent either before accumulation or within the accumulation path. Accumulation structures may include multiple parallel adder trees that may feed a hierarchical accumulator sized for the active format, where portions of the trees may be gated when a lower precision is active. Normalization circuitry may then form output values using a wider intermediate precision and may apply scale factors at a defined compute‑block granularity so that numerical behavior may remain consistent as precision changes.

Output values 114 may carry the numerical results produced by compute engine 120 to memory or to downstream logic under supervision of processing system 110. In some embodiments, output values 114 may include the primary results in the selected numeric format and may also include lightweight per‑block metadata (such as saturation indicators or scale indices) that may accompany the results, while completion and exception indications may be conveyed over mode/precision/control 112. Output values 114 may be written to destination buffers identified by processing system 110 so that downstream software may consume the results without changing buffer shapes when precision changes.

By way of example, processing system 110 may write configuration over mode/precision/control 112 to select a mode and a precision, specify a compute‑block size, provide operand and destination addresses, and assert a start indication. In response, compute engine 120 may load operands into operand storage, route elements through format preprocessing according to the selected precision, produce mantissa products and product exponents, apply alignment in or before the accumulation path, reduce partials through parallel adder trees and a hierarchical accumulator, and normalize at a wider intermediate precision with the configured scaling. Compute engine 120 may then commit output values 114 to the designated destination and assert a completion indication over mode/precision/control 112 so that processing system 110 may schedule subsequent work. If processing system 110 later selects a different precision using the same command structure, compute engine 120 may reuse shared datapath lanes and gating policies appropriate to that precision while continuing to deliver output values 114 at the same compute‑block granularity so that downstream software may remain unchanged.

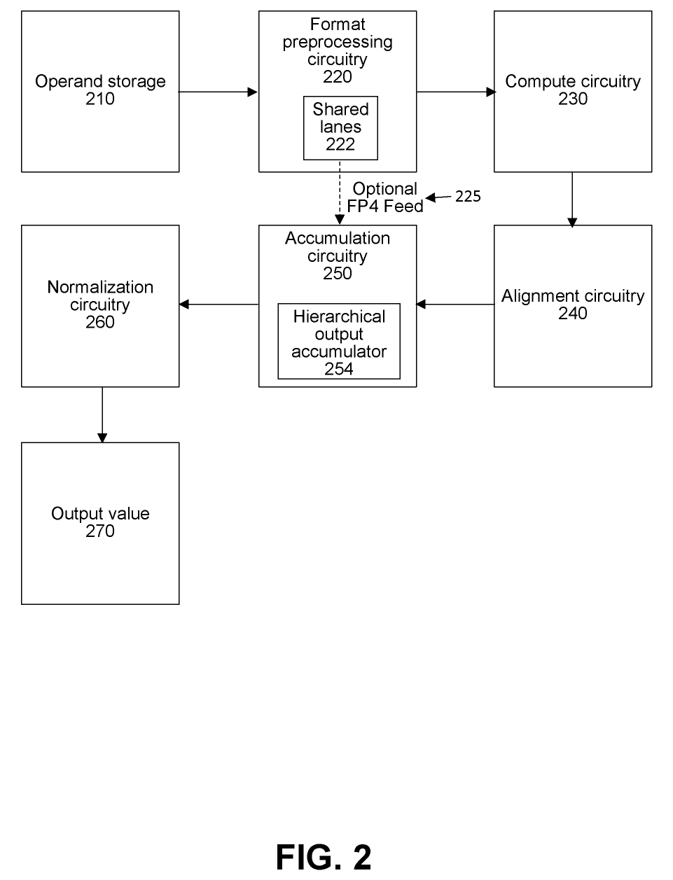

FIG. 2 is a block diagram of datapath components that implements the internal organization of compute engine referenced in FIG. 1. In the arrangement shown, operand storage 210 may supply operands to format preprocessing circuitry 220, which may route elements through shared lanes 222. From there, operands may be presented to compute circuitry 230, which may generate products and associated exponent information in a floating‑point mode. The resulting values may be provided to alignment circuitry 240, which may apply a power‑of‑two factor appropriate to the product exponent and the selected precision. Aligned partials may then be reduced by accumulation circuitry 250, which may include a hierarchical output accumulator 254 for staged combination of partial sums. Results from accumulation circuitry 250 may be normalized and scaled by normalization circuitry 260 to form output value 270 in the selected numeric format. An optional FP4 feed 225 from shared lanes 222 to accumulation circuitry 250 may be enabled in lower‑precision operation to simplify alignment and reduce switching activity, as explained below.

Operand storage 210 may stage input activations and weights so that data movement may overlap with computation. In some embodiments, operand storage 210 may include two or more buffers that may alternate between a loading phase and a compute phase. Such double‑buffering may allow compute circuitry 230 to remain supplied while new tiles of data are fetched, which may reduce idle cycles when batch sizes or matrix dimensions vary. Operand storage 210 may also maintain stride, base address, and block‑size parameters so that each fetch may deliver elements in the packing appropriate to the selected precision (for example, single eight‑bit elements or two four‑bit elements packed into an eight‑bit storage unit).

Format preprocessing circuitry 220 may route element representations of different bit widths through shared lanes 222 so that the same physical lanes may serve multiple precisions. In an integer mode, format preprocessing circuitry 220 may perform two’s‑complement sign handling prior to accumulation so that adder structures may be reused across modes. In compact floating‑point formats, format preprocessing circuitry 220 may establish mantissas for normal and subnormal values and, for very narrow formats, may apply limited alignment shifts prior to accumulation (for example, a bounded number of shifts in a four‑bit floating‑point precision). Using shared lanes 222 in this way may avoid duplicating interconnect for each precision and may allow lane utilization to remain high when elements are packed at lower width.

Optional FP4 feed 225 may provide a precision‑specific path from shared lanes 222 to accumulation circuitry 250 that may be enabled when a lower‑precision floating‑point mode (for example, a four‑bit floating‑point precision) is selected. In such operation, alignment for the compact format may be simplified to a small, bounded set of shifts applied by format preprocessing circuitry 220. When those shifts have already placed contributions in the appropriate range, optional FP4 feed 225 may allow pre‑aligned, precision‑appropriate contributions to be injected directly into accumulation circuitry 250, bypassing alignment circuitry 240. This option may reduce switching activity in alignment circuitry 240, may shorten the critical path for compact formats, and may allow gating of hardware not needed at the selected precision, while maintaining the same outward control model as higher‑precision operation. In other modes (for example, an eight‑bit floating‑point precision), optional FP4 feed 225 may be disabled so that exponent‑based alignment remains within alignment circuitry 240.

Compute circuitry 230 may perform per‑lane multiplication and, in a floating‑point mode, may produce a mantissa product and a product exponent. The compute structures may be organized to stream elements from shared lanes 222 while maintaining a steady issue rate under either single‑element (eight‑bit) or packed‑element (four‑bit‑in‑eight) traffic. In some embodiments, compute circuitry 230 may combine operand signs early so that subsequent alignment and accumulation may operate on sign‑corrected quantities. For workloads that partition inputs into groups for scaling (for example, to maintain a consistent compute‑block size across precisions), compute circuitry 230 may mark group boundaries or provide lane tags so that accumulation circuitry 250 and normalization circuitry 260 may apply the intended per‑group treatment.

Alignment circuitry 240 may apply scaling derived from a product exponent so that mantissa products may be aligned prior to reduction. In a floating‑point mode using a wider compact format (for example, an eight‑bit floating‑point precision), alignment circuitry 240 may use a power‑of‑two factor to position partials for efficient reduction in accumulation circuitry 250. In a lower‑precision floating‑point mode, alignment circuitry 240 may be partially or fully gated when optional FP4 feed 225 is enabled, because the limited shifts performed by format preprocessing circuitry 220 may have already placed contributions within the desired alignment range. This division of labor may allow exponent‑driven alignment where it is most beneficial, while conserving power when a compact format admits a simpler scheme.

Accumulation circuitry 250 may include multiple parallel adder trees that may reduce aligned partials to intermediate sums. Some implementations may size a first subset of adder trees to accept packed lower‑precision inputs and may include a second subset with smaller input widths for other modes, with gating controls that may disable unused subsets to reduce dynamic and leakage power. Hierarchical output accumulator 254 may combine tree outputs in stages to a final intermediate result with sufficient headroom for subsequent normalization and scaling. In designs that keep the compute‑block size constant across precisions, accumulation circuitry 250 may also maintain per‑group running partials so that normalization circuitry 260 may apply groupwise scaling without increasing block size at lower precision.

Normalization circuitry 260 may form output value 270 in the selected numeric format using a wider intermediate precision. For example, normalization circuitry 260 may apply per‑block or per‑group scale factors, perform rounding, and generate saturation indicators as needed. Performing normalization at a wider intermediate precision may preserve numerical fidelity when many partials are combined, particularly when lower‑precision inputs are used. After normalization, output value 270 may be written to a destination buffer designated by the controller so that downstream software may consume the results without changing buffer shapes when precision changes.

By way of example, a controller may select a floating‑point mode and an eight‑bit precision. Operand storage 210 may stage activations and weights while format preprocessing circuitry 220 may route eight‑bit elements through shared lanes 222. Compute circuitry 230 may produce mantissa products and product exponents; alignment circuitry 240 may apply power‑of‑two alignment; accumulation circuitry 250 and hierarchical output accumulator 254 may reduce partials; and normalization circuitry 260 may produce output value 270 with the requested scaling. In a later phase, the controller may select a four‑bit floating‑point precision. Format preprocessing circuitry 220 may apply bounded shifts and route packed elements through shared lanes 222; optional FP4 feed 225 may be enabled so that contributions may enter accumulation circuitry 250 directly; portions of alignment circuitry 240 may be gated; and normalization circuitry 260 may apply the configured per‑block or per‑group scaling so that output value 270 remains compatible with the same compute‑block granularity used in the higher‑precision phase.

In some implementations of the system illustrated in FIG. 2, compute engine 120 can be implemented as a compute-in/near-memory macro in which one or more memory arrays store weight values and at least a portion of compute circuitry 230 is integrated in or adjacent to the memory macro to perform multiply-accumulate operations using the stored weight values. In this embodiment, operand storage 210 may be positioned at an edge of the memory macro (and may include a double buffer) to stage input activations while weight data is accessed from the arrays. Format preprocessing circuitry 220 may be arranged along ingress paths into the macro (e.g., at or near read ports and/or at a boundary between operand storage 210 and compute circuitry 230) to route element representations of different bit widths through shared lanes 222, including routing packed element representations for a four-bit floating-point precision. Alignment circuitry 240 may be physically co-located with the macro datapath and may apply exponent-derived alignment for floating-point operation, while optional FP4 feed 225 may be enabled in lower-precision operation to inject pre-shifted contributions from shared lanes 222 toward accumulation circuitry 250 and reduce activity in alignment circuitry 240. Accumulation circuitry 250 may be instantiated per macro slice, per sub-array, or per local tile, with plural parallel adder trees feeding hierarchical output accumulator 254. Normalization circuitry 260 may be positioned at an output edge of the macro (or per macro tile) to apply block- or group-based scaling and to form output value 270 in a selected numeric format using a wider intermediate precision, under control of mode/precision/control 112 provided by processing system 110.

Additionally, or alternatively, the system illustrated in FIG. 2 can be implemented with compute engine 120 configured as a systolic array in which compute circuitry 230 comprises a plurality of compute cells arranged to stream operand values between neighboring compute cells while performing multiply-accumulate operations. In this embodiment, operand storage 210 and format preprocessing circuitry 220 may be located at one or more injection boundaries of the systolic array (e.g., along an edge for activations and an edge for weights) so that elements are routed through shared lanes 222 and prepared according to the selected mode and precision prior to entering the array. For floating-point operation, exponent information associated with per-cell products may be used to drive alignment circuitry 240 implemented at tile boundaries or along an output-facing region of the array, and in some implementations alignment circuitry 240 may be simplified or partially bypassed in a compact precision by enabling optional FP4 feed 225 so that bounded pre-alignment performed by format preprocessing circuitry 220 supplies contributions directly toward accumulation circuitry 250. Accumulation circuitry 250 may be implemented per tile, per row, per column, or per output-stationary region to reduce contributions emerging from the systolic array, with hierarchical output accumulator 254 combining tree outputs into a stabilized accumulated sum. Normalization circuitry 260 may be implemented per column or per tile output to apply compute-block scaling, perform dequantization and rounding using the wider intermediate precision, and emit output value 270 in the selected numeric format while maintaining a consistent compute-block granularity across precisions under supervision of processing system 110 via mode/precision/control 112.

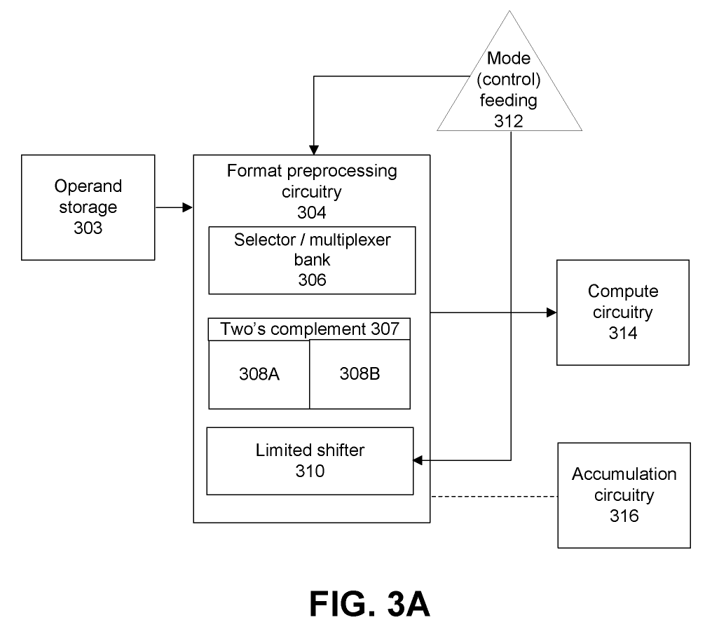

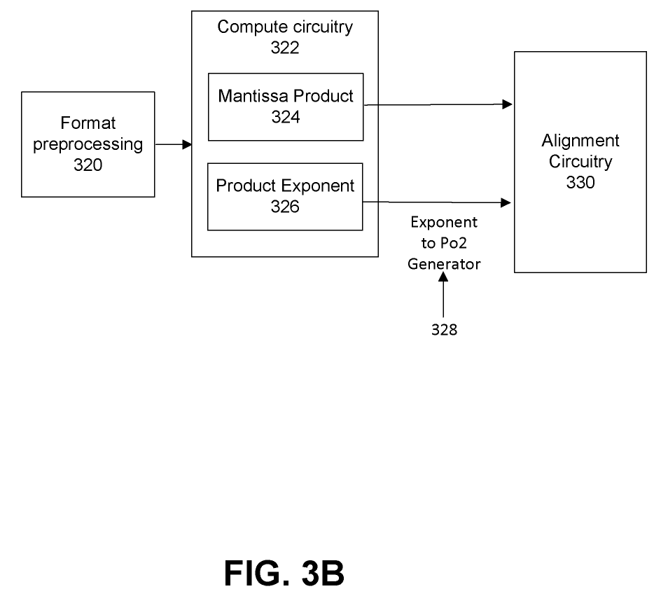

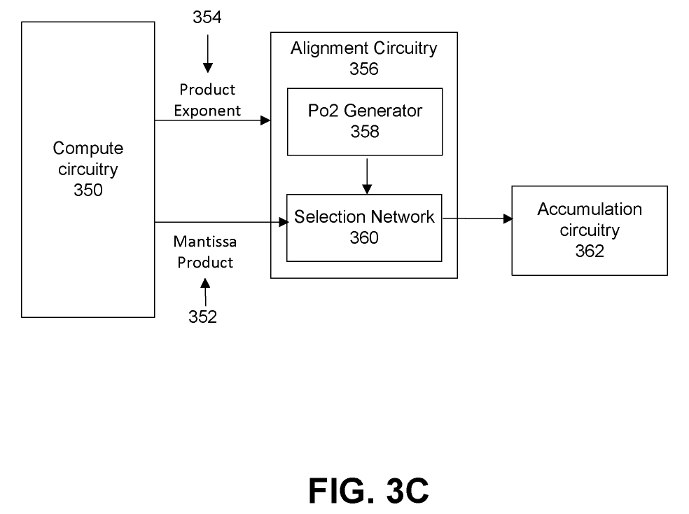

FIG. 3A is a block diagram that illustrates a format‑preprocessing stage within the internal organization of compute engine introduced in FIGS. 1–2. In the arrangement shown, operand storage 303 may provide operands to format preprocessing circuitry 304, which may include a selector‑multiplexer bank 306, a two’s complement 307 block having sub‑blocks 308A and 308B, and a limited shifter 310. Mode (control) feeding 312 may supply configuration and per‑operation controls to format preprocessing circuitry 304 and to limited shifter 310. Outputs of format preprocessing circuitry 304 may feed compute circuitry 314 and, in some modes, may also feed accumulation circuitry 316 through an optional connection as described below.

Operand storage 303 may stage input activations and weights so that data movement may overlap with downstream processing. In some embodiments, operand storage 303 may implement double‑buffering so one buffer may be loaded while the other may be consumed, which may reduce bubbles when switching between tiles or batches. Operand storage 303 may also maintain base addresses, strides, and element‑packing descriptors so that elements may be presented to format preprocessing circuitry 304 either as single eight‑bit items or as two four‑bit items packed into an eight‑bit storage unit, depending on the selected precision.

Format preprocessing circuitry 304 may adapt incoming operands to the active mode and precision while reusing shared datapath lanes across formats. To that end, format preprocessing circuitry 304 may (i) select and route operands of different bit widths through common lanes, (ii) condition signs and magnitudes according to the arithmetic mode, (iii) prepare mantissas for normal and subnormal floating‑point values, and (iv) apply bounded alignment shifts for compact floating‑point formats prior to accumulation. By placing these transformations up front, format preprocessing circuitry 304 may allow downstream compute and reduction blocks to operate with stable assumptions regardless of whether operands are eight‑bit floating‑point, packed four‑bit floating‑point, or integers, which may simplify control and may reduce the need for format‑specific datapaths deeper in the pipeline. In lower‑precision floating‑point operation, format preprocessing circuitry 304 may perform at most a small, fixed number of shifts that may be sufficient to place contributions within the range expected by the reduction trees, thereby enabling optional bypass behavior to accumulation circuitry 316 as described below.

Selector-multiplexer bank 306 may route element representations of different bit widths through shared datapath lanes (e.g., shared lanes of FIG. 2). For example, when an eight-bit floating-point precision is selected, selector-multiplexer bank 306 may forward one eight-bit element per lane; when a four-bit floating-point precision is selected, selector-multiplexer bank 306 may forward two four-bit elements packed within an eight-bit storage unit along the same lane. Using shared lanes in this way may avoid duplicating interconnect, may preserve alignment with minimum burst sizes, and may maintain lane utilization as element width decreases.

Two’s complement 307 may perform sign handling when an integer mode is selected so that the same downstream adder structures may be reused for integer and floating‑point operation. Sub‑block 308A may act on a first operand stream (for example, activations), and sub‑block 308B may act on a second operand stream (for example, weights). This separation may allow independent enable/bypass control, per‑stream saturation or clipping policy, and timing isolation between streams. When a floating‑point mode is active, two’s complement 307 may be bypassed so that floating‑point sign and exponent handling may be preserved for the compute stage.

Limited shifter 310 may apply a bounded set of alignment shifts prior to accumulation when a compact floating-point precision is selected. For instance, in a four-bit floating-point precision, limited shifter 310 may perform a small, fixed number of shifts (e.g., six or fewer) that may be sufficient to position contributions for the reduction trees and/or enable the optional connection to accumulation circuitry 316 without engaging a wider exponent-based alignment path. Bounding the shift range may keep the critical path short and area modest while still aligning partials for correct accumulation in compact formats. When an eight-bit floating-point precision is selected, limited shifter 310 may be configured for a fixed or zero-shift policy consistent with downstream alignment behavior. The limited shifter 310 may be implemented with a programmable or configurable bound on the number of shifts, where the bound may be selected based on the numeric format, exponent range, and/or performance configuration; in some embodiments the bound may correspond to a small number of shifts (e.g., about six) for a compact format, while other embodiments use a different bound.

Mode (control) feeding 312 may be connected to format preprocessing circuitry 304, and may convey configuration that may set the active mode (for example, floating‑point or integer) and select the precision (for example, eight‑bit floating‑point or four‑bit floating‑point). Through this connection, mode (control) feeding 312 may choose lane‑routing options in selector‑multiplexer bank 306 so that either single eight‑bit elements or two four‑bit elements packed into an eight‑bit unit may be forwarded along shared lanes. The same connection may enable or bypass two’s complement 307 (including independent control of sub‑blocks 308A and 308B for separate operand streams), and may select whether the optional connection from format preprocessing circuitry 304 to accumulation circuitry 316 is active in compact floating‑point operation. Mode (control) feeding 312 may also inject per‑group tags or compute‑block identifiers so that downstream normalization and scaling may be performed at a consistent block size across precisions, while keeping the software‑visible command structure unchanged when switching formats.

Mode (control) feeding 312 may be connected to limited shifter 310, and may program the shift behavior used for compact formats prior to accumulation. For example, mode (control) feeding 312 may specify a bounded shift range for a four‑bit floating‑point precision (such as a small, fixed maximum number of shifts) so that contributions may be positioned for the reduction trees without invoking wider exponent‑based alignment, and may select a fixed or zero‑shift policy for an eight‑bit floating‑point precision to maintain timing uniformity. This connection may further allow per‑group or per‑lane shift configuration, gating or bypass of limited shifter 310 when not required, and selection of overflow or saturation handling, which together may reduce switching activity and critical‑path length while preserving numerical behavior across modes.

Compute circuitry 314 may receive preprocessed elements from format preprocessing circuitry 304 and, in a floating‑point mode, may produce mantissa products together with product‑exponent information for later alignment and reduction. Compute circuitry 314 may be organized to stream either single eight‑bit elements or packed four‑bit elements at line rate so that precision changes may not require changes to software scheduling. In an integer mode, compute circuitry 314 may consume two’s‑complement values provided by two’s complement 307.

An optional connection from format preprocessing circuitry 304 to accumulation circuitry 316 (illustrated as a dotted path) may be enabled in compact floating‑point operation. When limited shifter 310 has already applied the bounded shifts appropriate to the compact format, the optional connection may inject contributions directly into accumulation circuitry 316, bypassing exponent‑based alignment that may be used for wider compact formats. This option may reduce switching activity in intermediate alignment stages, may shorten the pipeline for compact modes, and may allow gating of hardware not needed at the selected precision, while preserving the same external command structure. When a wider compact precision is selected, the optional connection may be disabled so that compute circuitry 314 and any intermediate alignment stages may provide the exponent‑driven placement used by the reduction trees in accumulation circuitry 316.

By way of example, a controller may select a floating‑point mode with an eight‑bit precision via mode (control) feeding 312. Operand storage 303 may deliver one eight‑bit element per lane; selector‑multiplexer bank 306 may forward those elements; two’s complement 307 may be bypassed; limited shifter 310 may apply a fixed or zero‑shift policy consistent with downstream alignment; and compute circuitry 314 may generate mantissa products and exponent information for later stages. In a subsequent phase, the controller may select a four‑bit floating‑point precision. Operand storage 303 may deliver two packed four‑bit elements per lane; selector‑multiplexer bank 306 may route the packed data; limited shifter 310 may apply the bounded shifts for compact alignment; and the optional connection from format preprocessing circuitry 304 to accumulation circuitry 316 may be enabled so that compact‑format contributions may be accumulated without engaging wider‑format alignment behavior. Throughout, mode (control) feeding 312 may keep lane routing, sign handling, and shift policy synchronized with the selected mode and precision so that software may not need to change buffer shapes or command formats when switching between precisions.

FIG. 3B is a block diagram that illustrates a compute-and-alignment stage within the internal organization of a compute engine. In the arrangement shown, format preprocessing 320 may supply prepared operands to compute circuitry 322, which may generate a mantissa product 324 and a product exponent 326 in a floating-point mode. Outputs of compute circuitry 322 may be provided to alignment circuitry 330 so that contributions may be positioned for efficient reduction in downstream accumulation hardware. A signal path from product exponent 326 to alignment circuitry 330 may include an Exponent-to-PO2 generator 328, which may derive a power-of-two scaling control from the exponent as explained below.

Format preprocessing 320 may perform lane routing, sign conditioning, subnormal and normal handling, and bounded pre-accumulation shifts described for the format-preprocessing stage. In some embodiments, format preprocessing 320 may forward one eight-bit floating-point element per lane when a wider compact precision is selected, and may forward two four-bit floating-point elements packed into an eight-bit storage unit when a compact precision is selected. By presenting operands in a normalized lane form, format preprocessing 320 may allow compute circuitry 322 to operate at a steady issue rate across different precisions without altering software-visible tiling or buffer shapes. When an integer mode is selected, format preprocessing 320 may also supply two’s-complement values so that the same downstream datapaths may be reused.

Compute circuitry 322 may perform per-lane multiplication. In a floating-point mode, the multiplication may be factored so that a mantissa product 324 and a product exponent 326 may be produced. Compute circuitry 322 may also combine operand signs early so that later stages may treat magnitudes uniformly. As a result, mantissa product 324 may represent the scaled significand contribution, while product exponent 326 may represent an exponent offset associated with the pair of operands. Separating mantissa product 324 from product exponent 326 may allow downstream reduction structures to be reused across precisions while keeping numerical behavior consistent. In a wider compact precision, alignment circuitry 330 may apply power-of-two placement so that reduction-tree inputs may stay within defined ranges. In a compact precision, a bounded amount of pre-alignment work may already have been done by the format-preprocessing stage, and the exponent path through exponent-to-PO2 generator 328 may therefore be simplified or gated while the mantissa path may continue to feed alignment circuitry 330 for any residual placement used by the trees. This approach may reduce switching activity, may limit growth in shifter width, and may maintain a constant compute-block granularity so that software may not need to change scheduling when precision changes.

Alignment circuitry 330 may position contributions for accumulation by applying a power-of-two factor derived from product exponent 326. In some embodiments, alignment circuitry 330 may realize this placement as a shift-and-select network sized to reduction-tree inputs. In other embodiments, alignment circuitry 330 may cooperate with a fused multiply-accumulate path so that exponent-based alignment may occur within an accumulation datapath rather than as a standalone shift stage. Aligning partials in this manner may reduce redundant movement of intermediate results and may yield deterministic ranges for adder-tree inputs, which may simplify overflow handling and normalization policy.

Exponent-to-PO2 generator 328 may denote logic associated with the signal path from product exponent 326 to alignment circuitry 330. The label is not intended to imply that the arrow itself is the component; rather, it may indicate that along this path the exponent value may be translated into a power-of-two control, such as a shift amount, a one-hot select for a selection network, or gating bits for a partial-product placement network. In some embodiments, exponent-to-PO2 generator 328 may be implemented as a small combinational decode block co-located with alignment circuitry 330, and in other embodiments it may be implemented as control logic that sets selection signals on each cycle. Decoupling exponent-to-control derivation from the mantissa datapath may help keep mantissa product 324 on a short critical path while the derived control may arrive in time to steer alignment circuitry 330 deterministically.

By way of example, the controller may select a floating-point mode with an eight-bit precision. Format preprocessing 320 may forward one eight-bit element per lane. Compute circuitry 322 may generate mantissa product 324 and product exponent 326 each cycle. Exponent-to-PO2 generator 328 may translate product exponent 326 into a control word, and alignment circuitry 330 may apply that control to place mantissa product 324 into an input range expected by reduction trees. In a subsequent phase, the controller may select a four-bit floating-point precision. Format preprocessing 320 may forward two packed four-bit elements per lane and may have applied bounded shifts appropriate to the compact format. Exponent-to-PO2 generator 328 may be configured to a reduced set of control values or may be partially gated, while alignment circuitry 330 may apply any residual placement so that the same downstream reduction structures may be reused without changing the compute-block granularity.

FIG. 3C is a block diagram that illustrates an alignment stage that may position floating‑point products for reduction prior to accumulation. In the arrangement shown, compute circuitry 350 may generate two related outputs, including a mantissa product 352 and a product exponent 354. Product exponent 354 may be provided to alignment circuitry 356, and mantissa product 352 may be provided directly to selection network 360 within alignment circuitry 356. Alignment circuitry 356 may include a power‑of‑two generator 358 that may receive product exponent 354 and may produce a power‑of‑two control that may be consumed by selection network 360. Selection network 360 may then provide an aligned output to accumulation circuitry 362 so that multiple contributions may enter a reduction path with a consistent numeric alignment.

Compute circuitry 350 may perform multiplication and may output mantissa product 352 and product exponent 354 in a floating‑point mode. Compute circuitry 350 may be implemented in any suitable manner and may generally correspond to compute circuitry described in connection with prior figures, with FIG. 3C emphasizing the partitioning of the multiplication result into mantissa and exponent components for downstream alignment.

Mantissa product 352 may represent a significand‑domain contribution produced by multiplying operand mantissas (and, in some embodiments, applying sign combination such that the mantissa‑domain quantity is sign‑consistent for downstream placement and addition). Mantissa product 352 may be provided directly to selection network 360 so that selection network 360 may place, route, or otherwise position mantissa product 352 into an aligned representation without first requiring a wide arithmetic shift in the mantissa datapath. Sending mantissa product 352 to selection network 360 may allow alignment circuitry 356 to treat the mantissa datapath as a data input that is “placed” rather than “shifted,” which may support higher throughput and more deterministic timing because selection network 360 may be structured as a routing fabric with bounded depth. Mantissa product 352 may also carry, implicitly or explicitly, information that reflects operand classification performed upstream (for example, normal versus subnormal handling that establishes whether an implicit leading mantissa bit was present), so that the placed contribution corresponds to the numeric semantics of the selected floating‑point representation.

In some embodiments, mantissa product 352 may have a width that is greater than either operand mantissa width so that downstream accumulation does not immediately lose precision, and mantissa product 352 may be delivered in a form that is convenient for reduction structures. For example, mantissa product 352 may be provided as a contiguous bit field that selection network 360 may deposit into one of multiple predetermined bit‑position windows, allowing accumulation circuitry 362 to see a stable input format independent of exponent value.

Product exponent 354 may represent an exponent‑domain quantity associated with the same operand pair that produced mantissa product 352. Product exponent 354 may be formed from exponent information extracted from the operands (and, depending on representation, may reflect adjustments such as bias handling and operand classification effects), so that product exponent 354 may indicate how mantissa product 352 may be scaled by a factor of two to realize the full floating‑point product value. Product exponent 354 may be provided to alignment circuitry 356 because exponent information may be used to control where mantissa product 352 should be placed within an aligned representation that will be added with other contributions. In this way, product exponent 354 may act as a placement selector that drives alignment behavior, rather than requiring mantissa product 352 to be numerically multiplied by a large power‑of‑two value in the mantissa datapath.

Providing product exponent 354 to alignment circuitry 356 may also support gating and range limitation policies. For example, if a selected floating‑point format supports a limited exponent range, alignment circuitry 356 may restrict decoding to the supported range and may gate unused decode terms to reduce switching activity. In compact formats where bounded pre‑alignment shifts are performed upstream, product exponent 354 may still be conveyed to alignment circuitry 356 but may be used in a simplified manner (for example, through a reduced decode space or a smaller placement set) so that the accumulation interface remains consistent while hardware activity tracks the selected precision.

Alignment circuitry 356 may position mantissa product 352 for accumulation by applying a power‑of‑two factor corresponding to product exponent 354. Alignment circuitry 356 may be implemented so that exponent‑driven alignment is realized primarily through control and routing rather than through wide arithmetic operations on mantissa product 352. This approach may be useful in mixed‑precision engines because it may allow the same downstream reduction structures to accept aligned contributions across precisions while keeping the control problem explicit and deterministic.

In some embodiments, alignment circuitry 356 may also support different alignment behaviors depending on mode. For instance, in a floating‑point mode, alignment circuitry 356 may interpret product exponent 354 to determine placement of mantissa product 352. In an integer mode, alignment circuitry 356 may be configured so that selection network 360 performs routing appropriate to integer multiplication or direct accumulation behaviors, with exponent‑decode functionality reduced, bypassed, or gated when not required.

Power‑of‑two generator 358 may receive product exponent 354 and may translate that exponent information into a power‑of‑two control that represents the factor 2^(product exponent) used for floating‑point scaling. In some embodiments, power‑of‑two generator 358 may be implemented as decode or lookup circuitry that asserts one of many mutually exclusive control lines based on the exponent code, similar to an address‑decoder style structure. In that implementation style, the asserted control line may correspond to a specific placement choice (for example, “place into window k”) rather than producing a shifted mantissa numerically. In other embodiments, power‑of‑two generator 358 may produce a compact selection code or shift‑amount representation that selection network 360 may interpret to choose one of several placements. Power‑of‑two generator 358 may also be configured so that only a subset of exponent values is active under a selected precision, and unused decode terms may be gated to reduce switching when compact modes are selected.

Selection network 360 may receive mantissa product 352 as a data input and may receive the power‑of‑two control produced by power‑of‑two generator 358 as a control input. Selection network 360 may then place mantissa product 352 into a predetermined alignment position corresponding to the exponent‑derived control. In some embodiments, selection network 360 may be implemented as multiplexers, a crossbar, or a routing fabric that selects among multiple placement options without requiring a full‑width arithmetic shifter operating directly on mantissa product 352. For example, selection network 360 may deposit mantissa product 352 into one of several aligned “bins” or bit windows, where the selected window corresponds to the exponent‑derived power‑of‑two control. This may yield an aligned contribution whose numeric weight matches the exponent scaling, allowing accumulation circuitry 362 to add multiple aligned contributions using ordinary addition structures.

Selection network 360 may also support determinism and verification benefits. Because selection network 360 may map a given product exponent 354 to a defined placement, the interface into accumulation circuitry 362 may remain stable and predictable, which may simplify ensuring that reductions behave consistently across tiles, precisions, and workloads. Selection network 360 may further be designed so that placement options are bounded to those relevant to the supported exponent range, and so that unused paths may be gated in compact modes to reduce switching.

Selection network 360 may provide an aligned output to accumulation circuitry 362. Accumulation circuitry 362 may then reduce aligned contributions across lanes and/or time slices using reduction structures suitable for the selected precision. Supplying aligned contributions to accumulation circuitry 362 may reduce the need for additional per‑input alignment inside the reduction trees and may constrain partial‑sum growth in a predictable way, which may simplify overflow handling and downstream normalization behavior. In some embodiments, the aligned output may be sized to match the input expectations of parallel adder trees, and the mapping implemented by selection network 360 may be selected so that the majority of exponent placements fall within a common dynamic range for typical workloads.

By way of example, a controller may select a floating‑point mode using an eight‑bit floating‑point precision. Compute circuitry 350 may generate mantissa product 352 and product exponent 354. Product exponent 354 may be received by power‑of‑two generator 358, which may produce a decode or selection control corresponding to a power‑of‑two placement. Mantissa product 352 may be received by selection network 360, which may use the control from power‑of‑two generator 358 to place mantissa product 352 into an aligned representation. Selection network 360 may then provide the aligned contribution to accumulation circuitry 362 for reduction with other aligned contributions. In another example, when a compact precision such as four‑bit floating‑point is selected and bounded alignment shifts are performed earlier in the pipeline, power‑of‑two generator 358 may be simplified or partially gated and selection network 360 may use a reduced placement set while still presenting an aligned output to accumulation circuitry 362 so the accumulation interface remains consistent across precisions.

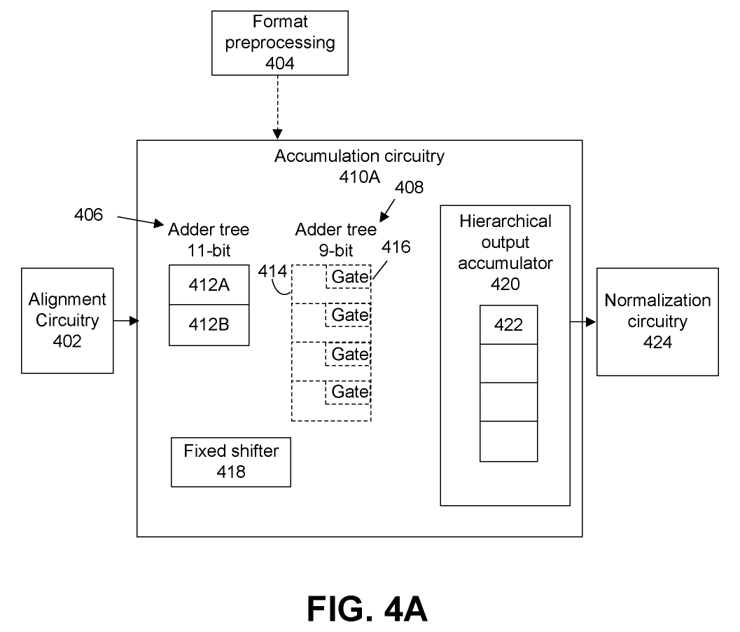

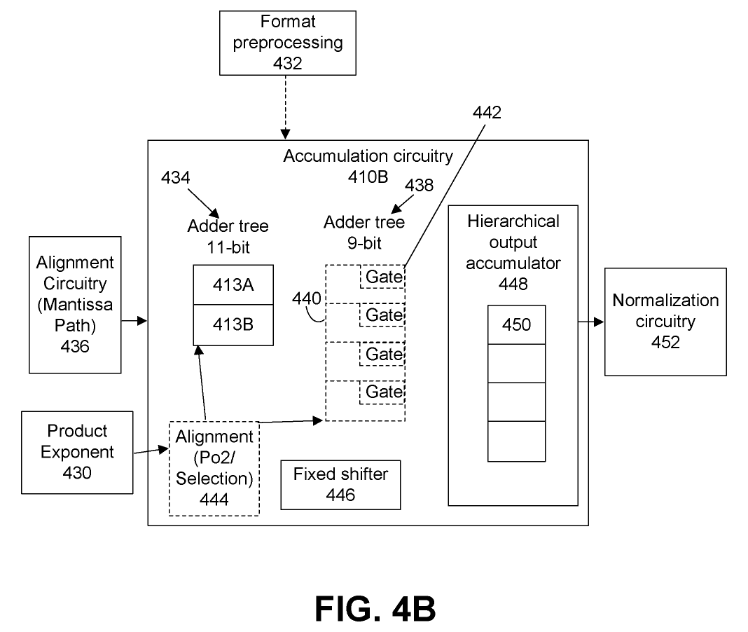

FIG. 4A is a block diagram that illustrates an accumulation stage that may reduce aligned contributions into a stable accumulated sum for subsequent formatting. In the arrangement shown, alignment circuitry 402 may provide aligned contributions to accumulation circuitry 410A. Format preprocessing 404 may also provide, through a dotted optional connection, contributions or preconditioned values to accumulation circuitry 410A in operating modes where bounded pre‑alignment is performed upstream. Within accumulation circuitry 410A, multiple adder‑tree structures may reduce inputs in parallel and may feed a hierarchical output accumulator 420. A fixed shifter 418 may apply a mode‑dependent fixed shift policy within the reduction path. The output of hierarchical output accumulator 420 may be provided to normalization circuitry 424, which may subsequently form an output value in a selected numeric format using an intermediate precision.

Alignment circuitry 402 may provide aligned contributions to accumulation circuitry 410A so that values entering the reduction trees share a consistent numeric alignment. In floating‑point operation, alignment circuitry 402 may position partial products according to exponent‑derived placement so that reduction trees can add contributions without requiring each tree input to perform independent alignment. Supplying aligned inputs to accumulation circuitry 410A may reduce redundant shifting inside the reduction fabric and may improve determinism of partial‑sum growth, which may simplify downstream normalization and overflow management.

Format preprocessing 404 may prepare operands or intermediate contributions for reduction, including routing different bit‑width element representations through shared lanes and, in some compact floating‑point modes, performing bounded pre‑accumulation shifts. The dotted optional connection from format preprocessing 404 to accumulation circuitry 410A may be enabled when the operating mode allows contributions to be presented in a form that is already positioned for reduction without relying on the full exponent‑driven alignment behavior. For example, in a lower‑precision floating‑point mode, format preprocessing 404 may apply a limited set of shifts sufficient to place contributions within a range accepted by the reduction trees. In that case, the optional connection may allow those pre‑shifted contributions to enter accumulation circuitry 410A directly, which may reduce switching activity in upstream alignment paths and may allow portions of alignment‑related logic to be gated. When a wider floating‑point precision is selected, the optional connection may be disabled so that the exponent‑driven placement produced by alignment circuitry 402 is used as the primary alignment mechanism feeding the reduction trees.

Accumulation circuitry 410A may reduce a set of aligned inputs into partial sums and then into an accumulated sum suitable for normalization. Accumulation circuitry 410A may include multiple parallel adder trees operating concurrently so that many lane contributions may be collapsed with tree depth rather than with a long serial chain. Parallel reduction may support high throughput because multiple additions may occur in the same cycle across separate trees, while the number of levels may scale with the logarithm of the input count. Accumulation circuitry 410A may also include mode‑dependent gating so that only the subset of the reduction fabric needed for the selected precision is active, which may reduce both dynamic and leakage power in compact modes.

Adder tree 11-bit406 may represent a higher‑input‑width reduction structure that may accept wider intermediate contributions associated with compact formats that pack multiple low‑precision elements into shared lanes. In some embodiments, adder tree 11-bit406 may be used to support accumulation of packed four‑bit operands by providing additional headroom in each tree input so that two packed contributions (or sign‑conditioned contributions) may be combined without immediate loss of significant bits. Sub‑blocks 412A and 412B may correspond to parallel slices or parallel tree instances that may operate concurrently on separate groups of inputs, separate lanes, or separate packed elements. Splitting the 11‑bit tree into 412A and 412B may allow the same structural template to serve two parallel streams, which may help preserve throughput when compact formats deliver more elements per storage unit. This arrangement may also simplify gating granularity, because each sub‑block may be enabled or disabled independently based on mode, lane utilization, or group scheduling.

Adder tree 9-bit 408 may represent a narrower‑input‑width reduction structure that may be sufficient for modes where inputs are not packed as densely or where upstream alignment produces a narrower intermediate contribution. In some embodiments, adder tree 9-bit 408 may include multiple tree instances or tree segments represented by sub‑blocks 414, allowing several reductions to proceed in parallel. Gate 416 may represent gating elements associated with portions of adder tree 9-bit 408, and gate 416 may be implemented as clock gating, power gating, or input isolation. In a compact precision mode, portions of adder tree 9-bit408 may be gated by gate 416 because the reduction capacity provided by adder tree 11-bit406 may be sufficient to accept packed contributions, and the additional 9‑bit trees may not be needed to meet throughput targets. Gating the unused tree segments may reduce switching activity and may lower leakage without changing the outward behavior of accumulation circuitry 410A. In a wider precision mode, additional tree segments within adder tree 9-bit408 may be enabled so that the reduction fabric can accept more independent aligned contributions per cycle, which may support a higher fan‑in alignment strategy driven by alignment circuitry 402.

Fixed shifter 418 may apply a mode‑dependent fixed shift policy within the accumulation path. In some embodiments, fixed shifter 418 may apply a fixed left shift in an eight‑bit floating‑point precision and may apply a zero shift in a four‑bit floating‑point precision. Applying a fixed shift rather than a per‑input variable shift may keep the critical path short and control simple, while still placing partial sums into a numerically convenient range for subsequent tree levels and the hierarchical output accumulator 420. Fixed shifter 418 may also support consistent scaling conventions across modes, particularly when the reduction fabric is shared between packed and unpacked representations.

Hierarchical output accumulator 420 may combine partial sums produced by the parallel adder trees into a stable accumulated sum. Rather than merging all tree outputs in a single wide adder, hierarchical output accumulator 420 may perform staged accumulation over multiple cycles or multiple internal levels, which may reduce fan‑in pressure and may improve timing. Element 422 may represent a register, latch bank, or accumulator stage within hierarchical output accumulator 420 that may store an intermediate accumulated value between stages. Maintaining intermediate state in 422 may allow accumulation circuitry 410A to accept new partial sums each cycle while previous partial sums are being combined, thereby sustaining throughput. Hierarchical output accumulator 420 may also support precision‑aware enabling of stages, where fewer stages may be active in compact modes and more stages may be active in wider modes, helping energy scale with required accumulation range.

The output of hierarchical output accumulator 420 may be provided to normalization circuitry 424. Normalization circuitry 424 may convert the accumulated sum into a selected numeric format and may apply scaling at a compute‑block granularity. Providing normalization circuitry 424 with an accumulated sum that is produced deterministically by hierarchical output accumulator 420 may simplify leading‑bit detection, rounding selection, and scale application. Locating dequantization and scaling functions in or alongside normalization circuitry 424 may also allow quantized workflows to be handled without requiring a separate post‑processing stage.

By way of example, in a wider floating‑point precision, alignment circuitry 402 may provide exponent‑aligned contributions into accumulation circuitry 410A, and both adder tree 11-bit406 and at least a portion of adder tree 9-bit408 may be enabled so that many aligned contributions may be reduced in parallel. Fixed shifter 418 may apply a fixed shift policy appropriate to the selected precision, and hierarchical output accumulator 420 may merge tree outputs over one or more stages, storing intermediate state in 422. The resulting accumulated sum may be provided to normalization circuitry 424 for formatting. In a compact floating‑point precision, format preprocessing 404 may apply bounded pre‑alignment shifts and the optional connection from format preprocessing 404 to accumulation circuitry 410A may be enabled. In that mode, gate 416 may gate off portions of adder tree 9-bit408, while adder tree 11-bit406 (including 412A and 412B) may accept packed contributions with additional headroom. Fixed shifter 418 may apply a reduced or zero shift policy appropriate to the compact format, and hierarchical output accumulator 420 may continue to produce an accumulated sum that normalization circuitry 424 may format at a consistent compute‑block granularity.

FIG. 4B is a block diagram that illustrates an alternate accumulation embodiment relative to FIG. 4A in which exponent‑based alignment may be integrated within accumulation circuitry 410B rather than being performed entirely upstream. In FIG. 4A, alignment circuitry upstream of the reduction fabric may provide aligned contributions into the accumulation stage. In FIG. 4B, the alignment function may be partitioned into a mantissa‑domain data path and an exponent‑domain control path, where alignment circuitry (mantissa path) 436 may deliver mantissa‑domain contributions into accumulation circuitry 410B while product exponent 430 may drive alignment (Po2/Selection) 444 to control placement and alignment as part of the reduction operation. This difference may be significant because it may enable a fused multiply‑accumulate style behavior in floating‑point modes, where exponent‑driven alignment may be applied at or within the adder trees while reductions are occurring, rather than requiring a separate full alignment stage to produce fully aligned products before accumulation.

Format preprocessing 432 may prepare contributions for reduction (including routing different bit‑width representations and, in some modes, performing bounded pre‑alignment shifts), and may operate as described in FIG. 4A. In FIG. 4B, format preprocessing 432 may provide contributions into accumulation circuitry 410B through a dotted optional connection when that mode of entry is enabled, as described below.

The dotted optional connection from format preprocessing 432 to accumulation circuitry 410B may indicate that, in some operating modes, format preprocessing 432 may inject contributions directly into accumulation circuitry 410B. This may be useful in compact floating‑point modes where bounded pre‑alignment shifts are performed prior to accumulation so that full exponent‑driven placement is not required for each contribution. In other modes, the optional path may be disabled so that exponent‑driven alignment control is applied through alignment (Po2/Selection) 444.

Accumulation circuitry 410B may reduce incoming contributions into partial sums and then into an accumulated sum that may be provided to downstream formatting. Accumulation circuitry 410B may include parallel adder trees, a fixed shifter 446, selectively enabled regions such as region 440 with gate 442, and a hierarchical output accumulator 448, generally consistent in role with the accumulation circuitry described in FIG. 4A. In FIG. 4B, accumulation circuitry 410B may additionally include alignment (Po2/Selection) 444 as an integrated sub‑function that may apply exponent‑driven alignment control within the accumulation stage.

Alignment circuitry (mantissa path) 436 may represent the mantissa‑domain data portion of an aligned product contribution, and may be shown feeding accumulation circuitry 410B directly because, in this embodiment, the mantissa value itself may be treated as the data that will be reduced by the adder trees. The key point is that the mantissa contribution may be the quantity that is added, while exponent information may be used to determine the significance (placement) of that contribution relative to other contributions. Routing the mantissa contribution on alignment circuitry (mantissa path) 436 into accumulation circuitry 410B may allow the mantissa datapath to remain regular and timing‑friendly, because it may avoid requiring a wide per‑input variable shifter in the mantissa datapath before the reduction fabric. Instead, the mantissa contribution may enter the reduction fabric and be placed under control of exponent‑derived selection signals.

In some embodiments, alignment circuitry (mantissa path) 436 may carry mantissa‑domain values that already reflect upstream operand classification (for example, normal/subnormal handling) and sign combination performed earlier, so that the value entering the reduction fabric may be numerically consistent with the selected representation. This mantissa‑domain path may therefore represent the “payload” of the multiplication result that will be accumulated.

Product exponent 430 may represent exponent‑domain information associated with the same multiplication event that produced the mantissa‑domain contribution on alignment circuitry (mantissa path) 436. Product exponent 430 may be derived from operand exponent fields (and representation‑specific adjustments) so that product exponent 430 may indicate the power‑of‑two scaling needed to align the mantissa contribution with other contributions prior to addition. Product exponent 430 may not itself be a value that is summed in the accumulator; instead, it may drive how the mantissa contribution should be aligned so that additions occur at a common numeric reference.

Product exponent 430 may therefore be routed to alignment (Po2/Selection) 444 rather than directly into the adder trees as a data input, because its role may be to generate placement/alignment control, not to be accumulated. This separation may help depict one of the primary differences between FIGS. 4A and 4B. FIG. 4B illustrates an embodiment where exponent information may be carried as control into the accumulation stage, which may enable alignment and reduction to be fused together.

Alignment (Po2/Selection) 444 may represent exponent‑driven placement logic that may be integrated within accumulation circuitry 410B. Alignment (Po2/Selection) 444 may be shown as a dotted box which may indicate that this functionality may be optional, mode‑dependent, and/or selectively enabled within accumulation circuitry 410B. In floating‑point modes that rely on exponent semantics, alignment (Po2/Selection) 444 may be enabled to translate product exponent 430 into placement control that determines the power‑of‑two alignment applied to the mantissa contribution. In compact modes where bounded pre‑alignment shifts are performed earlier (for example, by format preprocessing 432), alignment (Po2/Selection) 444 may be simplified, bypassed, or partially gated because full exponent‑driven placement may not be required for every contribution.

Alignment (Po2/Selection) 444 may include power‑of‑two generation behavior that maps product exponent 430 to a power‑of‑two control and may include selection behavior that uses that control to drive placement within the reduction fabric. In some embodiments, the power‑of‑two generation behavior may be implemented using decode or lookup logic that produces mutually exclusive placement controls corresponding to exponent values. The selection behavior may then drive placement points in the reduction fabric so that the mantissa contribution arriving via alignment circuitry (mantissa path) 436 may be inserted at the correct significance as it enters, or as it propagates within, the adder trees. This arrangement may allow alignment to be realized as routing/selection control applied within the accumulation stage rather than as a separate variable shift stage upstream.

This split may reflect a data‑versus‑control separation. Alignment circuitry (mantissa path) 436 may carry the mantissa‑domain data that will be reduced. Product exponent 430 may carry control information that specifies where that data should be placed to realize correct floating‑point alignment. Alignment (Po2/Selection) 444 may convert the control information into placement signals that are applied to the reduction fabric. By doing so, the accumulation stage may receive a mantissa contribution and simultaneously receive placement control, allowing alignment and reduction to be fused into one pipeline region.

Adder tree 11-bit 434 may be a higher‑input‑width reduction structure that may accept wider intermediate contributions and may be used in modes where additional headroom is beneficial, such as packed low‑precision operation. Sub‑blocks 413A and 413B may represent parallel slices or parallel tree instances, and may operate as described for the corresponding parallel sub‑blocks in FIG. 4A.

Adder tree 9-bit438 may provide additional parallel reduction capacity using a narrower input width, and may operate as described in FIG. 4A.

Region 440 may depict portions of the reduction fabric that may be selectively enabled, and gate 442 may represent clock gating, power gating, or input isolation for those portions. Region 440 and gate 442 may operate as described in FIG. 4A so that unused portions may be deactivated in lower‑precision operation.

Fixed shifter 446 may apply a mode‑dependent fixed shift policy within the accumulation datapath, and may operate as described in FIG. 4A.

Hierarchical output accumulator 448 may combine partial sums produced by the adder trees into a stable accumulated sum, and may operate as described in FIG. 4A. Internal stage 450 may represent an internal register or accumulator stage used for staged accumulation, also as described in FIG. 4A.

Normalization circuitry 452 may receive the accumulated sum produced by hierarchical output accumulator 448 and may format the sum into a selected numeric format, and may operate as described for normalization circuitry in FIG. 4A.

FIG. 4A may illustrate an embodiment where alignment is largely performed upstream so the accumulation fabric receives already‑aligned contributions. FIG. 4B may illustrate an alternate embodiment where exponent alignment is integrated into accumulation circuitry 410B by carrying the mantissa contribution on alignment circuitry (mantissa path) 436 and carrying exponent information on product exponent 430 into alignment (Po2/Selection) 444, which applies placement control within the reduction fabric. This alternate embodiment may be useful for implementers who wish to fuse exponent‑driven placement with reduction to reduce separate alignment stages, reduce intermediate buffering, and enable precision‑dependent gating of alignment control within the accumulation stage.

In some embodiments, accumulation circuitry 410B implements a fused parallel adder-tree architecture in which multiple parallel reduction trees are provided, where at least a first subset (e.g., adder tree 11-bit434) uses a larger input width (e.g., about 11 bits) to accept packed compact-format contributions and at least a second subset (e.g., adder tree 9-bit438) uses a smaller input width (e.g., about 9 bits) for other contributions, and one or more subsets (e.g., region 440) are clock-gated or power-gated by gate 442 responsive to the selected precision. In some embodiments, one or more of the reduction trees (e.g., 434 and/or 438) has a fan-in of at least 16 inputs, and outputs from multiple trees are combined by a higher-level combine stage implemented by hierarchical output accumulator 448 and/or internal stage 450 prior to formatting by normalization circuitry 452. In some embodiments, fixed shifter 446 and/or a shift stage within or coupled to hierarchical output accumulator 448 applies one or more mode-dependent left shifts (for example, staged left shifts such as by 2 bits and/or by up to 30 bits) to position partial sums for the higher-level combination while maintaining bounded shifter complexity.

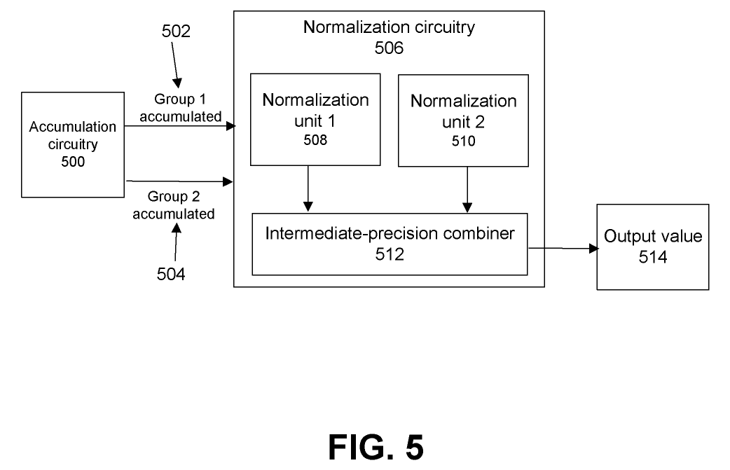

FIG. 5 is a block diagram that illustrates an example normalization arrangement in which accumulated results may be processed in parallel sub‑paths and then combined at an intermediate precision to produce a formatted output. In the arrangement shown, accumulation circuitry 500 may provide accumulated values to normalization circuitry 506, including a first accumulated group output labeled group 1 accumulated 502 and a second accumulated group output labeled group 2 accumulated 504. Normalization circuitry 506 may include normalization unit 1 508 and normalization unit 2 510 that may respectively process the group outputs, and an intermediate-precision combiner 512 that may combine normalized group results to form output value 514.

Accumulation circuitry 500 may reduce aligned contributions into one or more accumulated results, and may be implemented in a manner consistent with the accumulation circuitry described in FIGS. 4A–4B. For purposes of FIG. 5, accumulation circuitry 500 may be understood as producing groupwise accumulated values (such as group 1 accumulated 502 and group 2 accumulated 504) that are ready for formatting, scaling, and rounding within normalization circuitry 506.

Group 1 accumulated 502 and group 2 accumulated 504 may represent accumulated results corresponding to different groups of input activations, lanes, rows, columns, tiles, or other partitions used by the compute engine. The depiction of two groups may be an example and may be non‑limiting. In some embodiments, the set of input activations for a compute block may be partitioned into at least two groups so that each group may be accumulated independently and may be scaled and normalized independently. This partitioning may be useful when operating in a lower‑precision floating‑point mode because smaller precisions may benefit from a smaller effective scale granularity to preserve dynamic range, reduce quantization error, and limit accumulation error growth. In some embodiments, the groups may correspond to halves of a compute block (for example, two sub‑blocks that together form a compute block of thirty‑two elements), although other partitions may be used depending on the block size and the precision in use.

In some embodiments, groupwise accumulation may be used to maintain a constant compute‑block size across numeric formats. For example, if a higher‑precision mode would naturally accumulate a block of thirty‑two elements with a single normalization pass, a lower‑precision mode might otherwise prefer a smaller block size to preserve accuracy. By accumulating the lower‑precision data as multiple groups (e.g., group 1 accumulated 502 and group 2 accumulated 504) and then combining the normalized group results, the architecture may preserve the compute‑block size presented to downstream software while still applying a finer scale granularity internally.

Normalization circuitry 506 may receive one or more accumulated group values from accumulation circuitry 500 and may form output value 514 in a selected numeric format using a wider intermediate precision. In some embodiments, normalization circuitry 506 may perform one or more of: applying scale factors associated with a compute block or a group, performing dequantization within the normalization path, applying exponent correction or shift selection appropriate to the selected format, performing rounding, and handling saturation or flush-to-zero behavior. Normalization circuitry 506 may be configured so that these behaviors track the selected precision and mode, while presenting a stable output interface.

Normalization circuitry 506 may be arranged to normalize group outputs independently before combination. This may allow each group to use a scale factor appropriate to the magnitude distribution of that group, which may be useful in compact formats where a single scale shared across a larger block may lead to loss of resolution for smaller‑magnitude values. In some embodiments, a higher‑precision floating‑point mode may employ a single activation scale shared across multiple groups, while a lower‑precision floating‑point mode may employ at least two activation scales corresponding to the groups. This arrangement may support accuracy goals in lower‑precision operation while preserving a consistent external compute‑block size.

Normalization unit 1 508 and normalization unit 2 510 may each operate on a respective accumulated group value. For example, normalization unit 1 508 may normalize and scale group 1 accumulated 502, and normalization unit 2 510 may normalize and scale group 2 accumulated 504. The depiction of two normalization units may be an example and may be non‑limiting; however, in some embodiments two normalization units may be operative in a lower‑precision mode to maintain a compute‑block size of thirty‑two across numeric formats. In that case, using two normalization units may allow two groupwise accumulations to be normalized in parallel so that throughput is maintained even when groupwise scaling is applied.

Each normalization unit may apply a scale factor and may perform dequantization and rounding using an intermediate precision wider than the final output format. In some embodiments, each normalization unit may include internal headroom (guard width) so that rounding decisions and exponent adjustments may be made without premature loss of significance. Each normalization unit may also generate intermediate results in a format suitable for the intermediate-precision combiner 512, which may allow combination to occur without collapsing back to the low‑precision format prematurely.

Intermediate-precision combiner 512 may receive the outputs of normalization unit 1 508 and normalization unit 2 510 and may combine them using an intermediate precision addition. In some embodiments, the intermediate precision may include at least twenty‑two bits so that the combination may preserve fidelity when merging normalized group results. Combining at intermediate precision may be useful because each group may have been normalized using its own scale (or using a shared scale under a different mode), and performing the combine at a wider precision may reduce rounding artifacts and accumulation error that could occur if the combine were performed after truncating back to a compact output format.

Intermediate-precision combiner 512 may therefore act as a bridge between groupwise normalization and final formatting. In some embodiments, intermediate-precision combiner 512 may implement a floating‑point addition in an intermediate format and may then pass a combined intermediate result forward for final formatting into output value 514. In other embodiments, intermediate-precision combiner 512 may accumulate more than two normalized group results, and FIG. 5 may be understood as showing an example with two inputs rather than a strict limit.

Output value 514 may represent the final formatted output produced by normalization circuitry 506. Output value 514 may be in the selected numeric format (for example, an eight‑bit floating‑point format or a four‑bit floating‑point format, depending on mode) and may reflect scaling and rounding performed within normalization circuitry 506. In some embodiments, output value 514 may be written to a destination buffer and may optionally be accompanied by metadata such as saturation indicators or scale identifiers, while still presenting a stable output interface to downstream consumers.

By way of example, in a higher‑precision floating‑point mode, accumulation circuitry 500 may provide accumulated group values where a single activation scale may be shared across groups. Normalization unit 1508 and normalization unit 2510 may apply the shared scale (or an equivalent per‑group configuration) and may produce intermediate results that intermediate-precision combiner 512 may add at the intermediate precision to produce output value 514. In a lower‑precision floating‑point mode, accumulation circuitry 500 may provide groupwise accumulated results and at least two activation scales may correspond to the groups. Normalization unit 1508 and normalization unit 2510 may apply the respective group scales and may normalize using the wider intermediate precision, and intermediate-precision combiner 512 may then combine the normalized group results so output value 514 corresponds to a compute‑block sized output while internal processing uses groupwise scaling to preserve numerical behavior.

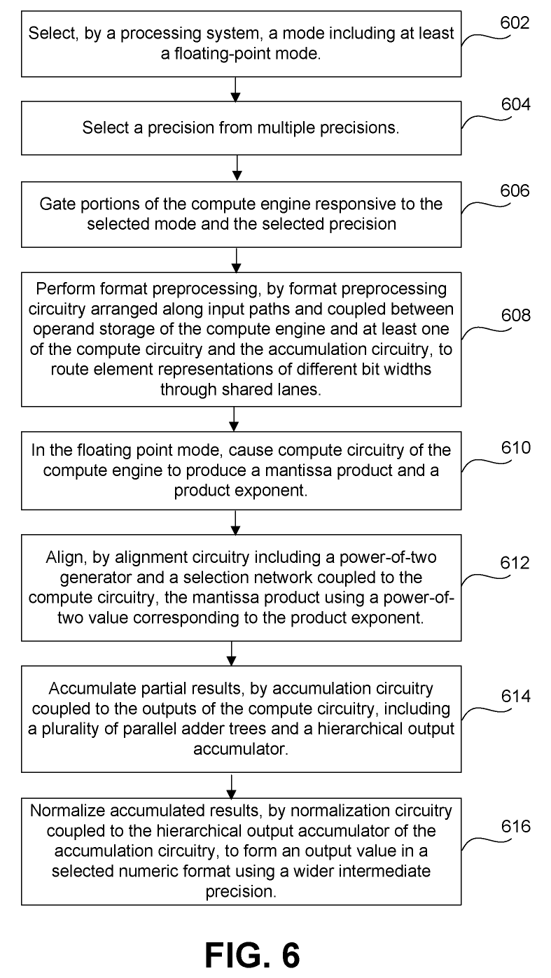

FIG. 6 is a flow diagram that illustrates an example method of operating a compute engine across mode selection, precision selection, gating, datapath preparation, computation, alignment, accumulation, and normalization. The ordering shown may be an example; in some embodiments, one or more steps may be repeated, omitted, or performed with overlapping timing while remaining consistent with the disclosed techniques.

In step 602, a processing system may select an operating mode that establishes arithmetic semantics for subsequent processing. The selected mode may include at least a floating‑point mode, and in some embodiments may also include other modes such as an integer mode. Selecting the mode may control how operands are interpreted, how sign handling is performed, and which datapath features are enabled or bypassed. For example, selecting the floating‑point mode may configure downstream logic to treat exponent information as meaningful for alignment and normalization, whereas selecting a different mode may configure sign handling and placement behavior differently.

In step 604, the processing system may select a precision from multiple supported precisions so the compute engine may operate with a chosen tradeoff among throughput, power, and numerical fidelity. The precision selection may control operand packing and lane usage, the width and utilization of reduction structures, and the formatting behavior used to emit results. In some embodiments, selecting the precision may also determine whether certain operations are performed in parallel across multiple sub‑paths (for example, by partitioning work into groups for later combination) so that the compute engine can maintain a consistent external block granularity while internally adapting to the selected precision.

In step 606, the processing system may gate portions of the compute engine responsive to the selected mode and the selected precision so that activity more closely tracks the hardware resources needed for that operating point. Gating may include clock gating, power gating, or input isolation, and may be applied to datapath sub‑blocks such as adder‑tree subsets, alignment/selection logic, shifters, or normalization sub‑paths. For example, when a compact precision is selected, some reduction resources may not be required to meet a target throughput, and gating those resources may reduce switching activity and energy while preserving the same outward behavior. When a wider precision is selected, additional resources may be enabled so that more parallel work can proceed each cycle.

In step 608, format preprocessing circuitry may prepare operands for the selected mode and precision and may route element representations of different bit widths through shared lanes. This preprocessing may include selecting whether a lane carries a single wider element or multiple packed narrower elements, applying mode‑dependent sign handling (for example, two’s‑complement handling in an integer mode), and performing any bounded pre‑alignment shifts that may be useful for compact floating‑point operation. Coupling the preprocessing circuitry along the input paths may allow downstream compute and accumulation structures to reuse the same physical lanes across formats without duplicating interconnect. In some embodiments, the preprocessing circuitry may also generate or forward per‑group identifiers or scale selection information so that later normalization can apply scaling consistently with the chosen compute‑block policy.

In step 610, when the floating‑point mode is selected, compute circuitry may produce a mantissa product and a product exponent. The mantissa product may represent the significand‑domain contribution resulting from multiplying operand mantissas, while the product exponent may represent exponent information associated with that contribution. Producing these two outputs may allow downstream alignment to be driven explicitly by exponent semantics rather than by treating each product as an already‑aligned fixed‑point value. In some embodiments, compute circuitry may also combine sign information so that later stages can treat the mantissa product as sign‑consistent for placement and accumulation.

In step 612, alignment circuitry may align the mantissa product using a power‑of‑two value corresponding to the product exponent. The alignment circuitry may include a power‑of‑two generator and a selection network coupled to the compute circuitry. The power‑of‑two generator may translate the product exponent into a power‑of‑two control representation, and the selection network may use that control to place the mantissa product into an aligned representation suitable for addition with other contributions. In some embodiments, this alignment may be realized as routing/placement control rather than as a wide arithmetic shift, which may support deterministic alignment behavior and bounded latency. In some embodiments, alignment functionality may be integrated with the reduction path so that alignment is applied as part of a fused multiply‑accumulate style operation, while still being driven by the exponent‑derived power‑of‑two control.

In step 614, accumulation circuitry may accumulate partial results. The accumulation circuitry may be coupled to outputs of the compute circuitry and may include a plurality of parallel adder trees and a hierarchical output accumulator. The parallel adder trees may reduce many aligned contributions concurrently so that throughput is maintained while fan‑in is managed by tree depth. The hierarchical output accumulator may merge tree outputs into a stable accumulated sum over one or more stages, which may help manage carry growth and support continuous acceptance of new partial sums. In some embodiments, subsets of adder trees or accumulator stages may be enabled or gated responsive to the selected precision so that the active reduction fabric matches the operating point selected in steps 602–606.

In step 616, normalization circuitry may normalize accumulated results to form an output value in a selected numeric format using a wider intermediate precision. The normalization circuitry may be coupled to the hierarchical output accumulator of the accumulation circuitry so that normalization is performed on the stabilized accumulated sum produced after reduction. Using a wider intermediate precision may provide guard width for rounding and scaling and may reduce loss of significance before formatting the result into the selected output format. In some embodiments, normalization may apply scaling associated with a compute block and may perform dequantization within the normalization circuitry so that quantized workflows are handled without requiring a separate post‑processing stage. In some embodiments, normalization may be performed per group and group results may be combined at intermediate precision, while still producing a final output value in the selected numeric format.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

A number of implementations have been described. Nevertheless, it will be understood that various modifications may be made without departing from the spirit and scope of the disclosure. Accordingly, other implementations are within the scope of the following claims.

It is understood that the described systems or apparatuses are not mutually exclusive, and elements, components, materials, or steps described in connection with one example method, system, or apparatus may be combined with, or eliminated from, other disclosed methods, systems, or apparatuses in suitable ways to accomplish desired design objectives.

In the foregoing specification, the disclosed systems or apparatuses have been described with reference to numerous specific details that can vary from implementation to implementation. Certain adaptations and modifications of the described systems or apparatuses can be made. Various renditions of the disclosed systems or apparatuses can be apparent to those skilled in the art from consideration of the specification and practice of the present disclosure. It is intended that the specification and examples be considered as exemplary only.

Aspect I. A computing system comprising:

a processing system including one or more processors; and

a compute engine coupled to the processing system;

where the processing system is configured to:

select a mode including at least a floating-point mode;

and where the compute engine includes:

operand storage for operand values;

compute circuitry configured, in the floating-point mode, to produce a mantissa product and a product exponent;

alignment circuitry including a power-of-two generator and a selection network coupled to the compute circuitry;

accumulation circuitry coupled to the outputs of the compute circuitry, including a plurality of parallel adder trees and a hierarchical output accumulator;

format preprocessing circuitry arranged along input paths and coupled between the operand storage and at least one of the compute circuitry and the accumulation circuitry, and configured to route element representations of different bit widths through shared lanes; and

normalization circuitry coupled to the hierarchical output accumulator of the accumulation circuitry and configured to form an output value in a selected numeric format using a wider intermediate precision.

Aspect II. The computing system of any of Aspects I, wherein:

the processing system is further configured to select a precision from multiple precisions and to gate portions of the compute engine responsive to the selected mode and the selected precision;

the compute circuitry is further configured to combine operand signs;

the alignment circuitry, in the floating-point mode, aligns the mantissa product during multiplication using a power-of-two value corresponding to the product exponent;

the format preprocessing circuitry performs limited alignment shifts prior to accumulation; and

the accumulation circuitry enables only a subset of the plurality of adder trees responsive to the selected precision or numeric format.

Aspect III. The computing system of any of Aspects I–II, wherein the alignment circuitry is integrated within the accumulation circuitry such that, in the floating-point mode, alignment using the power-of-two value corresponding to the product exponent is performed as part of a fused multiply-accumulate path through the plurality of parallel adder trees.

Aspect IV. The computing system of any of Aspects I–III, wherein, when the selected precision includes the four-bit floating-point precision, the format preprocessing circuitry routes a packed element representation in which two four-bit lanes are stored within an eight-bit storage unit.

Aspect V. The computing system of any of Aspects I–IV, wherein, when the selected precision includes the four-bit floating-point precision, the format preprocessing circuitry performs limited alignment shifts including, for example, a bounded number of shifts prior to accumulation, wherein the bounded number is selected based on at least one of a numeric format, an exponent range, or a performance configuration.

Aspect VI. The computing system of any of Aspects I–V, wherein the accumulation circuitry includes at least two sets of adder trees having different input widths, including a first set having a greater input width and a second set having a smaller input width, and the processing system gates the second set in a lower-precision mode.

Aspect VII. The computing system of any of Aspects I–VI, wherein the normalization circuitry is configured to:

accumulate and normalize the output using a wider floating-point intermediate precision including at least twenty-two bits; and

apply scaling associated with a compute block, with dequantization performed within the normalization circuitry.

Aspect VIII. The computing system of any of Aspects I–VII, wherein the normalization circuitry includes two normalization units operative in a lower-precision mode to maintain a compute block size of thirty-two across numeric formats.

Aspect IX. The computing system of any of Aspects I–VIII, wherein:

the compute engine is implemented as a memory macro that includes one or more memory arrays configured to store weight values, and at least a portion of the compute circuitry is integrated in the memory macro to perform multiply-accumulate operations using the stored weight values; and

the operand storage includes a double buffer configured to enable simultaneous loading of operand values and computing of results.

Aspect X. The computing system of any of Aspects I–IX, wherein:

the compute engine processes a set of input activations by partitioning the set into at least two groups, performing accumulation for each group using a respective adder tree and a respective normalization-and-dequantization block, and combining normalized group results using an intermediate-precision addition; and

a floating-point mode with a first precision uses a single activation scale shared across the groups and a floating-point mode with a second lower precision uses at least two activation scales corresponding to the groups.

Aspect XI. The computing system of any of Aspects I–X, wherein the alignment circuitry effects alignment by applying a power-of-two factor derived from a product exponent within the accumulation circuitry and a shifter in the accumulation circuitry applies a fixed left shift in the eight-bit floating-point precision and a zero shift in a four-bit floating-point precision.

Aspect XII. The computing system of any of Aspects I–XI, wherein:

the plurality of parallel adder trees comprises a first subset having adders with a first input width sized to accept accumulation of packed four-bit operands and a second subset having adders with a smaller input width; and

gating portions of the compute engine comprises power-gating or clock-gating the second subset when the selected precision is the four-bit precision.

Aspect XIII. The computing system of any of Aspects I–XII, wherein the format preprocessing circuitry comprises selector multiplexers configured to at least one of: route a single eight-bit element representation along a first datapath lane or a route four-bit element representation packed in an eight-bit storage unit along shared datapath lanes to the compute circuitry.

Aspect XIV. The computing system of any of Aspects I–XIII, wherein the format preprocessing circuitry is configured to detect normal vs. subnormal and set an implicit leading mantissa bit to a first value for normals and to a second value for subnormals.

Aspect XV. The computing system of any of Aspects I–XIV, wherein the compute circuitry comprises a plurality of compute cells arranged as a systolic array configured to stream operand values between neighboring compute cells while performing multiply-accumulate operations.

Aspect XVI. The computing system of any of Aspects I–XV, wherein the mode selected by the processing system comprises an integer mode and the format preprocessing circuitry performs two’s-complement sign handling prior to accumulation.

Aspect XVII. A method of operating a compute engine of a computing system comprising:

selecting, by a processing system, a mode including at least a floating-point mode;

performing format preprocessing, by format preprocessing circuitry arranged along input paths and coupled between the operand storage and at least one of the compute circuitry and the accumulation circuitry, configured to route element representations of different bit widths through shared lanes;

in the floating-point mode, causing compute circuitry of the compute engine to produce a mantissa product and a product exponent;

aligning, by alignment circuitry including a power-of-two generator and a selection network coupled to the compute circuitry, the mantissa product using a power-of-two value corresponding to the product exponent;

accumulating partial results, by accumulation circuitry coupled to the outputs of the compute circuitry, including a plurality of parallel adder trees and a hierarchical output accumulator; and

normalizing accumulated results, by normalization circuitry coupled to the hierarchical output accumulator of the accumulation circuitry, configured to form an output value in a selected numeric format using a wider intermediate precision.

Aspect XVIII. The method of any of Aspects XVII, selecting a precision from multiple precisions; and

gating portions of the compute engine responsive to the selected mode and the selected precision,

wherein the selected precision includes at least one of an eight-bit floating-point precision and a four-bit floating-point precision.

Aspect XIX. The method of any of Aspects XVII–XVIII, wherein the alignment circuitry is integrated within the accumulation circuitry such that, in the floating-point mode, alignment using the power-of-two value corresponding to the product exponent is performed as part of a fused multiply-accumulate path through the plurality of parallel adder trees.

Aspect XX. The method of any of Aspects XVII–XIX, wherein, when the selected precision includes the four-bit floating-point precision, the format preprocessing circuitry routes a packed element representation in which two four-bit lanes are stored within an eight-bit storage unit.

Aspect XXI. The method of any of Aspects XVII–XX, wherein, when the selected precision includes the four-bit floating-point precision, the format preprocessing circuitry performs limited alignment shifts including a bounded number of shifts prior to accumulation, wherein the bounded number is selected based on at least one of a numeric format, an exponent range, or a performance configuration.

Aspect XXII. The method of any of Aspects XVII–XXI, wherein the accumulation circuitry includes at least two sets of adder trees having different input widths, including a first set having a greater input width and a second set having a smaller input width, and wherein the processing system gates the second set in a lower-precision mode.

Aspect XXIII. The method of any of Aspects XVII–XXII, wherein the normalization circuitry accumulates and normalizes using a wider floating-point intermediate precision including twenty-two bits and applies scaling associated with a compute block, with dequantization performed within the normalization circuitry.

Aspect XXIV. The method of any of Aspects XVII–XXIII, wherein the normalization circuitry includes two normalization units operative in a lower-precision mode to maintain a compute block size of thirty-two across numeric formats.

Aspect XXV. The method of any of Aspects XVII–XXIV, wherein a mode selected by the processing system includes an integer mode, and the format preprocessing circuitry performs two’s-complement sign handling prior to accumulation.

Aspect XXVI. An apparatus for processing operand values in multiple numeric formats, including:

a processing system configured to select a mode including at least a floating-point mode, to select a precision from multiple precisions, and to gate portions of the apparatus responsive to the selected mode and the selected precision;

operand storage for operand values;

compute circuitry configured, in the floating-point mode, to produce a mantissa product and a product exponent;

alignment circuitry including a power-of-two generator and a selection network coupled to the compute circuitry;

accumulation circuitry coupled to the outputs of the compute circuitry, including a plurality of parallel adder trees and a hierarchical output accumulator;

format preprocessing circuitry arranged along input paths and coupled between the operand storage and at least one of the compute circuitry and the accumulation circuitry, and configured to route element representations of different bit widths through shared lanes; and

normalization circuitry coupled to the hierarchical output accumulator of the accumulation circuitry, configured to form an output value in a selected numeric format using a wider intermediate precision.

What is claimed is:

1. A computing system, comprising:
a processing system including one or more processors; and
a compute engine coupled to the processing system,
wherein:
the processing system is configured to select a mode including at least a floating‑point mode;
the compute engine comprises:
operand storage for operand values;
compute circuitry configured, in the floating‑point mode, to produce a mantissa product and a product exponent;
alignment circuitry including a power‑of‑two generator and a selection network coupled to the compute circuitry;
accumulation circuitry coupled to the outputs of the compute circuitry, including a plurality of parallel adder trees and a hierarchical output accumulator;
format preprocessing circuitry arranged along input paths and coupled between the operand storage and at least one of the compute circuitry and the accumulation circuitry, and configured to route element representations of different bit-widths through shared lanes; and
normalization circuitry coupled to the hierarchical output accumulator of the accumulation circuitry, configured to form an output value in a numeric format using a wider intermediate precision.

2. The computing system of claim 1, wherein:
the processing system is further configured to select a precision from multiple precisions and to gate portions of the compute engine responsive to the selected mode and the selected precision;
the selected precision including at least one of an eight‑bit floating‑point precision and a four‑bit floating‑point precision;
the compute circuitry is further configured to combine operand signs;
the alignment circuitry is configured, in the floating‑point mode, to align the mantissa product during multiplication using a power‑of‑two value corresponding to the product exponent;
the format preprocessing circuitry is configured to perform limited alignment shifts prior to accumulation; and
the accumulation circuitry is configured to enable a subset of the plurality of adder trees responsive to the selected precision or the selected mode.

3. The computing system of claim 1, wherein at least a portion of the alignment circuitry is integrated within the accumulation circuitry such that, in the floating‑point mode, alignment using the power‑of‑two value corresponding to the product exponent is performed as part of a fused multiply‑accumulate path through the plurality of parallel adder trees.

4. The computing system of claim 2, wherein, when the selected precision includes the four‑bit floating‑point precision, the format pre‑processing circuitry is configured to route a packed element representation in which two four‑bit lanes are stored within an eight‑bit storage unit.

5. The computing system of claim 2, wherein, when the selected precision includes the four‑bit floating‑point precision, the format pre‑processing circuitry is configured to perform limited alignment shifts including a bounded number of shifts prior to accumulation, wherein the bounded number is selected based on at least one of a numeric format, an exponent range, or a performance configuration.

6. The computing system of claim 2, wherein the accumulation circuitry includes at least two sets of adder trees having different input widths, including a first set having a greater input width and a second set having a smaller input width, and wherein the processing system is configured to gate the second set when the selected precision is a lower‑precision.

7. The computing system of claim 1, wherein the normalization circuitry is configured to:
accumulate and normalize the output value using a wider floating‑point intermediate precision including at least twenty‑two bits; and
apply scaling associated with a compute block, with dequantization performed within the normalization circuitry.

8. The computing system of claim 2, wherein the normalization circuitry includes two normalization units operative when the selected precision is a lower‑precision mode to maintain a compute block size of thirty‑two across numeric formats.

9. The computing system of claim 1, wherein:
the compute engine is implemented as a memory macro that includes one or more memory arrays configured to store weight values, and
at least a portion of the compute circuitry is integrated in the memory macro to perform multiply-accumulate operations using the stored weight values; and
the operand storage includes a double buffer configured to enable simultaneous loading of operand values and computing of results.

10. The computing system of claim 2, wherein:
the compute engine is configured to process a set of input activations by:
partitioning the set into at least two groups,
performing accumulation for each group using a respective adder tree and a respective normalization-and-dequantization block, and
combining normalized group results using an intermediate-precision addition; and
a floating-point mode with a first selected precision uses a single activation scale shared across the groups and a second selected precision uses a floating-point mode with a second lower precision using at least two activation scales corresponding to the groups.

11. The computing system of claim 2, wherein:
the alignment circuitry effects alignment by applying a power-of-two factor derived from a product exponent within the accumulation circuitry;
a shifter in the accumulation circuitry applies a fixed left shift when the selected precision is an eight-bit floating-point precision and a zero shift when the selected precision is a four-bit floating-point precision.

12. The computing system of claim 2, wherein:
the plurality of parallel adder trees comprises a first subset having adders with a first input width sized to accept accumulation of packed four-bit operands and a second subset having adders with a second input width that is smaller than the first input width; and
gating portions of the compute engine comprises power-gating or clock-gating the second subset of adder trees when the selected precision is the four-bit precision.

13. The computing system of claim 1, wherein:
the format preprocessing circuitry comprises selector multiplexers configured to at least one of: route a single eight-bit element representation along a first datapath lane or route a four-bit element representation packed in an eight-bit storage unit along shared datapath lanes to the compute circuitry.

14. The computing system of claim 1, wherein the format preprocessing circuitry is configured to:
detect whether an operand value is a normal value or a subnormal value; and
set an implicit leading mantissa bit to a first value for normal values and to a second value for subnormal values.

15. The computing system of claim 1, wherein the compute circuitry comprises a plurality of compute cells arranged as a systolic array configured to stream operand values between neighboring compute cells while performing multiply-accumulate operations.

16. The computing system of claim 1, wherein:
the mode selected by the processing system comprises an integer mode; and
the format preprocessing circuitry is configured to perform two’s-complement sign handling prior to accumulation.

17. A method of operating a compute engine of a computing system, comprising:
selecting, by a processing system, a mode including at least a floating-point mode;
performing format preprocessing, by format preprocessing circuitry arranged along input paths and coupled between an operand storage and at least one of a compute circuitry and an accumulation circuitry, configured to route element representations of different bit widths through shared lanes;
in the floating-point mode, causing compute circuitry of the compute engine to produce a mantissa product and a product exponent;
aligning, by alignment circuitry including a power of two generator and a selection network coupled to the compute circuitry, the mantissa product using a power-of-two value corresponding to the product exponent;
accumulating partial results, by accumulation circuitry coupled to outputs of the compute circuitry, including a plurality of parallel adder trees and a hierarchical output accumulator; and
normalizing accumulated results, by normalization circuitry coupled to the hierarchical output accumulator of the accumulation circuitry, configured to form an output value in a numeric format using a wider intermediate precision.

18. The method of claim 17, further comprising:
selecting a precision from multiple precisions; and
gating portions of the compute engine responsive to the selected mode and the selected precision,
wherein the selected precision includes at least one of an eight-bit floating-point precision and a four-bit floating-point precision.

19. The method of claim 17, wherein the alignment circuitry is integrated within the accumulation circuitry such that, in the floating‑point mode, alignment using the power‑of‑two value corresponding to the product exponent is performed as part of a fused multiply‑accumulate path through the plurality of parallel adder trees.

20. An apparatus for processing operand values in multiple numeric formats, including:
a processing system configured to select a mode including at least a floating-point mode, to select a precision from multiple precisions, and to gate portions of the apparatus responsive to the selected mode and the selected precision;
operand storage for operand values;
compute circuitry configured, in the floating‑point mode, to produce a mantissa product and a product exponent;
alignment circuitry including a power‑of‑two generator and a selection network coupled to the compute circuitry;
accumulation circuitry coupled to the outputs of the compute circuitry, including a plurality of parallel adder trees and a hierarchical output accumulator;
format preprocessing circuitry arranged along input paths and coupled between the operand storage and at least one of the compute circuitry and the accumulation circuitry, and configured to route element representations of different bit-widths through shared lanes; and
normalization circuitry coupled to the hierarchical output accumulator of the accumulation circuitry, configured to form an output value in a numeric format using a wider intermediate precision.
